(19) United States
(12) Patent Application Publication
(10) Pub. No.: US 2025/0047351 A1
(43) Pub. Date: Feb. 6, 2025

(54) CAPABILITY SIGNALING FOR CODEBOOK REPORTING IN A FULL DUPLEX OPERATION

(71) Applicant: Qualcomm Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Mostafa KHOSHNEVISAN, San Diego, CA (US)

(21) Appl. No.: 18/364,806

(22) Filed: Aug. 3, 2023

(51) Int. Cl. H04B 7/06; H04L 5/00

(52) U.S. Cl. CPC H04B 7/0628; H04B 7/0626; H04B 7/0639; H04L 5/0048; H04L 5/14

(57) ABSTRACT

Various aspects of the present disclosure generally relate to wireless communication. In some aspects, a user equipment (UE) may transmit capability signaling associated with a codebook for a channel state information (CSI) report, the capability signaling indicating a maximum number of supported reference signal resources for codebook reporting in a full duplex operation. The UE may receive, based at least in part on the capability signaling, one or more CSI report configurations indicating a number of reference signal resources for the full duplex operation. Numerous other aspects are described.

Aspects of the present disclosure generally relate to wireless communication and to techniques and apparatuses for capability signaling for a full duplex (FD) operation.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include one or more memories and one or more processors coupled to the one or more memories. The one or more processors may be configured to transmit capability signaling associated with a codebook for a channel state information (CSI) report, the capability signaling indicating a maximum number of supported reference signal resources for codebook reporting in a full duplex operation. The one or more processors may be configured to receive, based at least in part on the capability signaling, one or more CSI report configurations indicating a number of reference signal resources for the full duplex operation.

Some aspects described herein relate to an apparatus for wireless communication at a network node. The apparatus may include one or more memories and one or more processors coupled to the one or more memories. The one or more processors may be configured to receive capability signaling associated with a codebook for a CSI report, the capability signaling indicating a maximum number of supported reference signal resources for codebook reporting in a full duplex operation. The one or more processors may be configured to transmit, based at least in part on the capability signaling, one or more CSI report configurations indicating a number of reference signal resources for the full duplex operation.

Some aspects described herein relate to an apparatus for wireless communication at a UE. The apparatus may include one or more memories and one or more processors coupled to the one or more memories. The one or more processors may be configured to cause the UE to transmit capability signaling associated with a codebook for a CSI report, the capability signaling indicating a maximum number of supported reference signal resources for codebook reporting in a full duplex operation. The one or more processors may be configured to cause the UE to receive, based at least in part on the capability signaling, one or more CSI report configurations indicating a number of reference signal resources for the full duplex operation.

Some aspects described herein relate to an apparatus for wireless communication at a network node. The apparatus may include one or more memories and one or more processors coupled to the one or more memories. The one or more processors may be configured to cause the network node to receive capability signaling associated with a codebook for a CSI report, the capability signaling indicating a maximum number of supported reference signal resources for codebook reporting in a full duplex operation. The one or more processors may be configured to cause the network node to transmit, based at least in part on the capability signaling, one or more CSI report configurations indicating a number of reference signal resources for the full duplex operation.

Some aspects described herein relate to a method of wireless communication performed at a UE. The method may include transmitting capability signaling associated with a codebook for a CSI report, the capability signaling indicating a maximum number of supported reference signal resources for codebook reporting in a full duplex operation. The method may include receiving, based at least in part on the capability signaling, one or more CSI report configurations indicating a number of reference signal resources for the full duplex operation.

Some aspects described herein relate to a method of wireless communication performed at a network node. The method may include receiving capability signaling associated with a codebook for a CSI report, the capability signaling indicating a maximum number of supported reference signal resources for codebook reporting in a full duplex operation. The method may include transmitting, based at least in part on the capability signaling, one or more CSI report configurations indicating a number of reference signal resources for the full duplex operation.

Some aspects described herein relate to a non-transitory computer-readable medium that stores a set of instructions for wireless communication by a UE. The set of instructions, when executed by one or more processors of the UE, may cause the UE to transmit capability signaling associated with a codebook for a CSI report, the capability signaling indicating a maximum number of supported reference signal resources for codebook reporting in a full duplex operation. The set of instructions, when executed by one or more processors of the UE, may cause the UE to receive, based at least in part on the capability signaling, one or more CSI report configurations indicating a number of reference signal resources for the full duplex operation.

Some aspects described herein relate to a non-transitory computer-readable medium that stores a set of instructions for wireless communication by a network node. The set of instructions, when executed by one or more processors of the network node, may cause the network node to receive capability signaling associated with a codebook for a CSI report, the capability signaling indicating a maximum number of supported reference signal resources for codebook reporting in a full duplex operation. The set of instructions, when executed by one or more processors of the network node, may cause the network node to transmit, based at least in part on the capability signaling, one or more CSI report configurations indicating a number of reference signal resources for the full duplex operation.

Some aspects described herein relate to an apparatus for wireless communication. The apparatus may include means for transmitting capability signaling associated with a codebook for a CSI report, the capability signaling indicating a maximum number of supported reference signal resources for codebook reporting in a full duplex operation. The apparatus may include means for receiving, based at least in part on the capability signaling, one or more CSI report configurations indicating a number of reference signal resources for the full duplex operation.

Some aspects described herein relate to an apparatus for wireless communication. The apparatus may include means for receiving capability signaling associated with a codebook for a CSI report, the capability signaling indicating a maximum number of supported reference signal resources for codebook reporting in a full duplex operation. The apparatus may include means for transmitting, based at least in part on the capability signaling, one or more CSI report configurations indicating a number of reference signal resources for the full duplex operation.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of full duplex (FD) communications, in accordance with the present disclosure.

FIG. 5 is a diagram illustrating examples of FD communications, in accordance with the present disclosure.

FIG. 6 is a diagram illustrating an example of a subband full duplex (SBFD) slot format, in accordance with the present disclosure.

FIG. 7 is a diagram illustrating an example of a channel state information (CSI) reporting for SBFD symbols and non-SBFD symbols, in accordance with the present disclosure.

FIG. 8 is a diagram illustrating an example associated with capability signaling for codebook reporting in an FD operation, in accordance with the present disclosure.

FIGS. 9-10 are diagrams illustrating example processes associated with capability signaling for codebook reporting in an FD operation, in accordance with the present disclosure.

FIG. 11 is a diagram of an example apparatus for wireless communication, in accordance with the present disclosure.

FIG. 12 is a diagram illustrating an example of a hardware implementation for an apparatus employing a processing system, in accordance with the present disclosure.

FIG. 13 is a diagram illustrating an example implementation of code and circuitry for an apparatus, in accordance with the present disclosure.

FIG. 14 is a diagram of an example apparatus for wireless communication, in accordance with the present disclosure.

FIG. 15 is a diagram illustrating an example of a hardware implementation for an apparatus employing a processing system, in accordance with the present disclosure.

FIG. 16 is a diagram illustrating an example implementation of code and circuitry for an apparatus, in accordance with the present disclosure.

### DETAILED DESCRIPTION

A user equipment (UE) may transmit a channel state information (CSI) report to a network node. The CSI report may be based at least in part on a first CSI report configuration and a second CSI report configuration. The first CSI report configuration may be associated with a subband full duplex (SBFD) operation. In the SBFD operation, an SBFD slot/symbol may be used to convey both downlink data and uplink data. The second CSI report configuration may be associated with a non-SBFD operation (e.g., a half-duplex (HD) operation). The CSI report may be associated with the two CSI report configurations corresponding to SBFD/HD. The two CSI report configurations may both be associated with a same channel state information reference signal (CSI-RS) resource (e.g., a single CSI-RS resource). The CSI-RS resource May be associated with both the SBFD operation and the HD operation. The CSI-RS resource may be associated with occasions in both SBFD/HD slots.

In this example, due to both CSI report configurations being associated with the same CSI-RS resource, the CSI-RS resource may be counted twice in terms of a UE capability for a CSI report framework, a Type I single panel codebook, a Type I multi-panel codebook, a Type II codebook, a Type II codebook with port selection, and/or an enhanced Type II (e-Type-II) codebook. The CSI-RS resource may be counted twice in terms of the UE capability based at least in part on the CSI-RS resource being associated with the two CSI report configurations corresponding to SBFD/HD. In some examples, the CSI-RS resource may be counted two or more times in terms of the UE capability, depending on a number of CSI report configurations, which may correspond to a number of possible duplex operations. When the CSI-RS resource is counted twice in terms of the UE capability, a limitation on a number of CSI-RS resources to be configured may be imposed on the UE. For example, when a network node needs to configure X CSI-RS resources in HD, the UE may need to support (2×X) CSI-RS resources (e.g., two times X CSI-RS resources) for SBFD, where X is an integer value. The UE may count the number of CSI-RS resources as two, even though only the CSI-RS resource is used, which may cause the UE to reach a maximum count more quickly, as compared to when the CSI-RS resource is not counted two times. As a result, the network node may configure in FD a different number of reports which was supported in legacy mode (HD) (e.g., the network node may be unable to configure in FD the same number of reports which was supported in the legacy mode), as the UE capability may limit the number of reports configured. Further, for the SBFD operation, the UE would need to be able to support a larger number of CSI-RS resources, which may create an undue capability burden on the UE, and may thereby degrade a performance of the UE.

In some aspects, a UE may transmit, to a network node, capability signaling associated with a codebook for a CSI report. The capability signaling may indicate a maximum number of supported CSI-RS resources for codebook reporting in an SBFD operation. In some aspects, the capability signaling may be based at least in part on changed counting criteria for the SBFD operation. For a calculation of the maximum number of supported CSI-RS resources, a number of CSI-RS resources and a number of CSI-RS ports associated with one CSI-RS resource may be counted N times based at least in part on the one CSI-RS resource being referred to by N CSI-RS report settings and the N CSI-RS report settings having a same duplexing type, and N is an integer value. The same duplexing type may be an SBFD type or an HD type. Alternatively, for the calculation of the maximum number of supported CSI-RS resources, a number of CSI-RS resources and a number of CSI-RS ports associated with one CSI-RS resource may be counted a maximum of N1 or N2 times (e.g., max (N1, N2) may be used for counting) based at least in part on the one CSI-RS resource being referred to by N1 CSI-RS report settings for HD and N2 CSI-RS report settings for SBFD, and N1 and N2 are integer values.

In some aspects, the capability signaling may be based at least in part on CSI codebook UE features for the SBFD operation. The capability signaling may indicate first codebook UE features associated with an HD operation and second codebook UE features associated with the SBFD operation. The first codebook UE features may be used for counting the maximum number of supported resources for the HD operation. The second codebook UE features may be used for counting the maximum number of supported resources for the SBFD operation. Alternatively, the capability signaling may indicate codebook UE features associated with the HD operation, codebook UE features associated with the SBFD operation, and/or codebook UE features associated with both the HD operation and the SBFD operation. The codebook UE features associated with the HD operation may be used for counting the maximum number of supported resources for the HD operation. The codebook UE features associated with the SBFD operation may be used for counting the maximum number of supported resources for the SBFD operation.

In some aspects, depending on the changed counting criteria for the SBFD operation or the codebook UE features for the SBFD operation, the maximum number of supported resources may be appropriately counted for the HD operation or the SBFD operation. The UE may not count the one CSI-RS resource twice in terms of a UE capability based at least in part on the CSI-RS resource being associated with two CSI report configurations corresponding to SBFD/HD. The UE may not reach a maximum count more quickly, as compared to when the one CSI-RS resource is counted two times. As a result, in SBFD, the UE may not be required to support a larger number of CSI-RS resources, which may prevent an undue capability burden on the UE, thereby improving a performance of the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

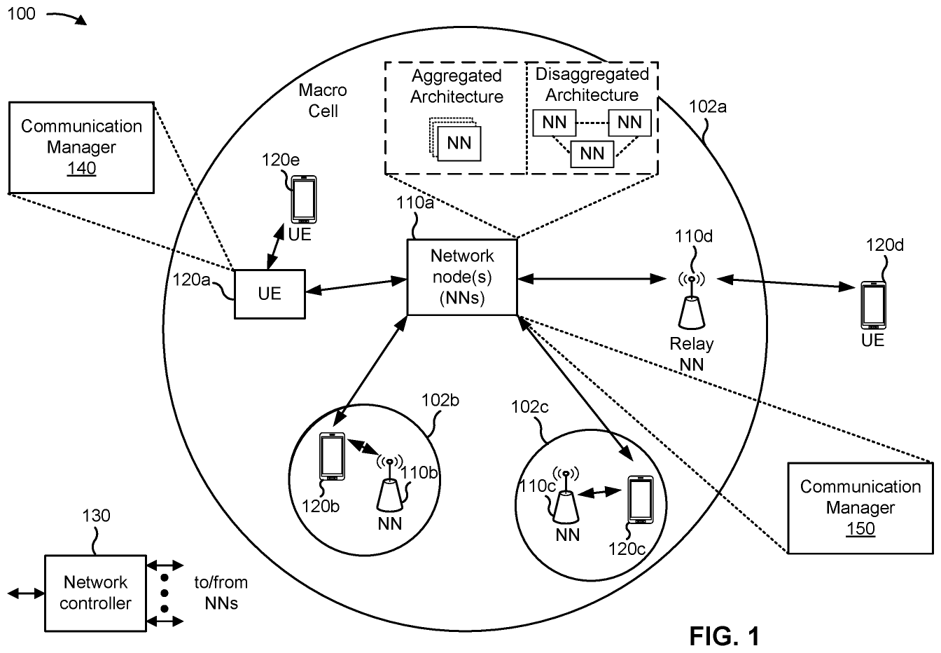

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHZ). It should be understood that although a portion of FRI is greater than 6 GHz, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may transmit capability signaling associated with a codebook for a CSI report, the capability signaling indicating a maximum number of supported reference signal resources for codebook reporting in a full duplex operation; and receive, based at least in part on the capability signaling, one or more CSI report configurations indicating a number of reference signal resources for the full duplex operation. Additionally, or alternatively, the communication manager 140 may perform one or more other operations described herein.

In some aspects, a network node (e.g., the network node 110) may include a communication manager 150. As described in more detail elsewhere herein, the communication manager 150 may receive capability signaling associated with a codebook for a CSI report, the capability signaling indicating a maximum number of supported reference signal resources for codebook reporting in a full duplex operation; and transmit, based at least in part on the capability signaling, one or more CSI report configurations indicating a number of reference signal resources for the full duplex operation. Additionally, or alternatively, the communication manager 150 may perform one or more other operations described herein.

As indicated above, FIG. 1 is provided as an example. Other examples may differ from what is described with regard to FIG. 1.

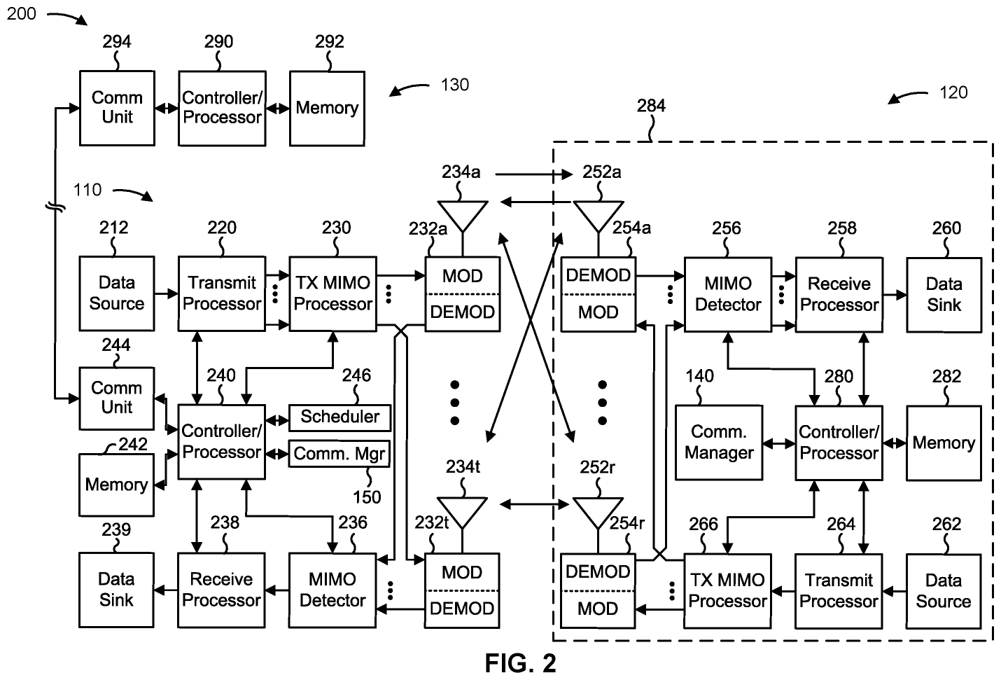

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a transmit MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the transmit MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the transmit MIMO processor 230. The transceiver may be used by a processor (e.g., the controller/processor 240) and the memory 242 to perform aspects of any of the methods described herein.

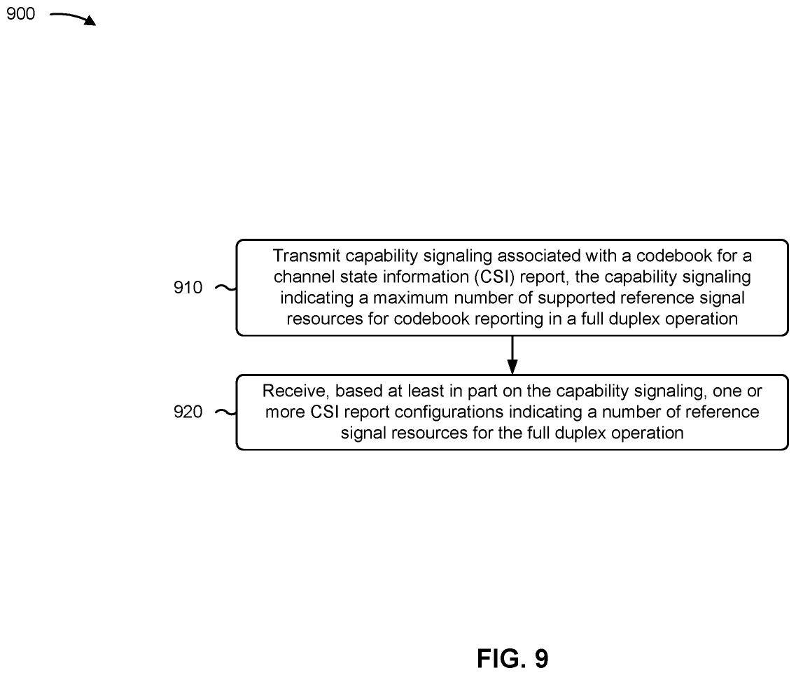

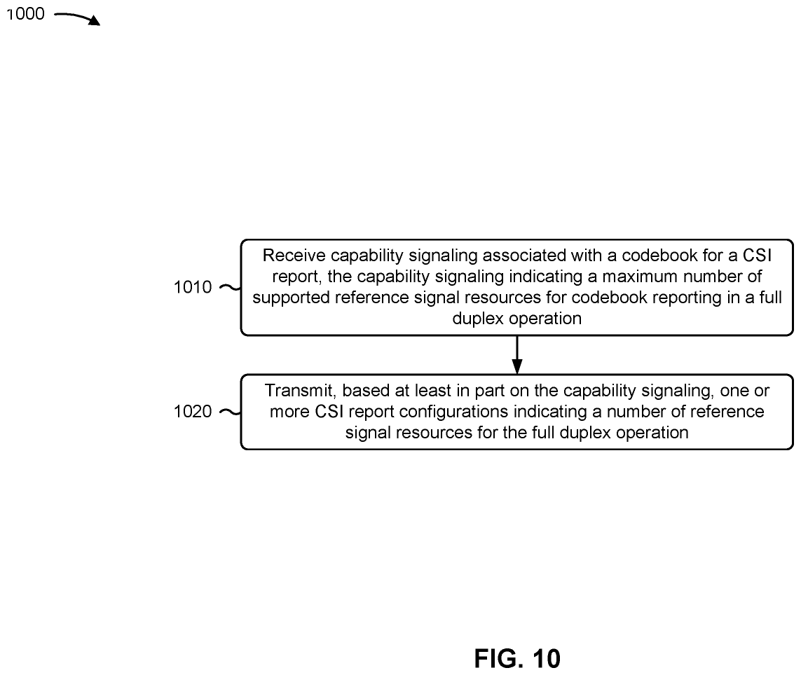

The controller/processor 240 of the network node 110, the controller/processor 280 of the UE 120, and/or any other component(s) of FIG. 2 may perform one or more techniques associated with capability signaling for codebook reporting in an FD operation, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting capability signaling associated with a codebook for a CSI report, the capability signaling indicating a maximum number of supported reference signal resources for codebook reporting in a full duplex operation; and/or means for receiving, based at least in part on the capability signaling, one or more CSI report configurations indicating a number of reference signal resources for the full duplex operation. The means for the UE to perform operations described herein may include, for example, one or more of communication manager 140, antenna 252, modem 254, MIMO detector 256, receive processor 258, transmit processor 264, transmit MIMO processor 266, controller/processor 280, or memory 282.

In some aspects, a network node (e.g., the network node 110) includes means for receiving capability signaling associated with a codebook for a CSI report, the capability signaling indicating a maximum number of supported reference signal resources for codebook reporting in a full duplex operation; and/or means for transmitting, based at least in part on the capability signaling, one or more CSI report configurations indicating a number of reference signal resources for the full duplex operation. The means for the network node to perform operations described herein may include, for example, one or more of communication manager 150, transmit processor 220, transmit MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the transmit MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

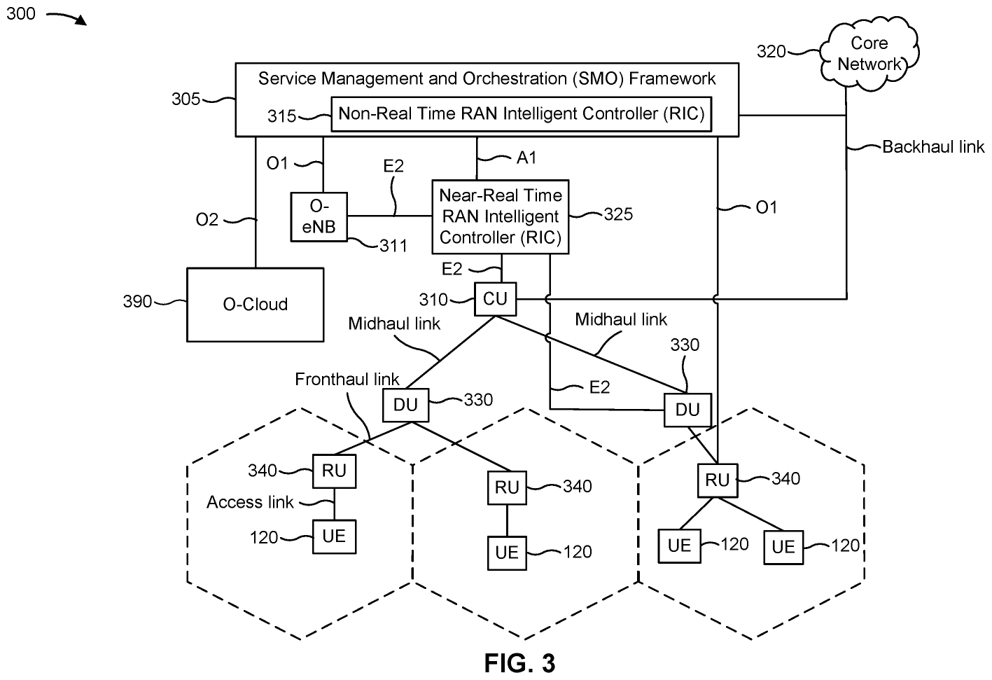

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A full duplex (FD) operation may involve an in-band full duplex (IBFD) operation, in which a transmission and a reception may occur on the same time and frequency resource. A downlink direction and an uplink direction may share the same IBFD time/frequency resource based at least in part on a full or partial overlap. Alternatively, the FD operation may involve an SBFD (or flexible duplex) operation, in which a transmission and a reception may occur at the same time but on different frequency resources. A downlink resource may be separated from an uplink resource in a frequency domain. In the SBFD operation, no downlink and uplink overlap in frequency may occur.

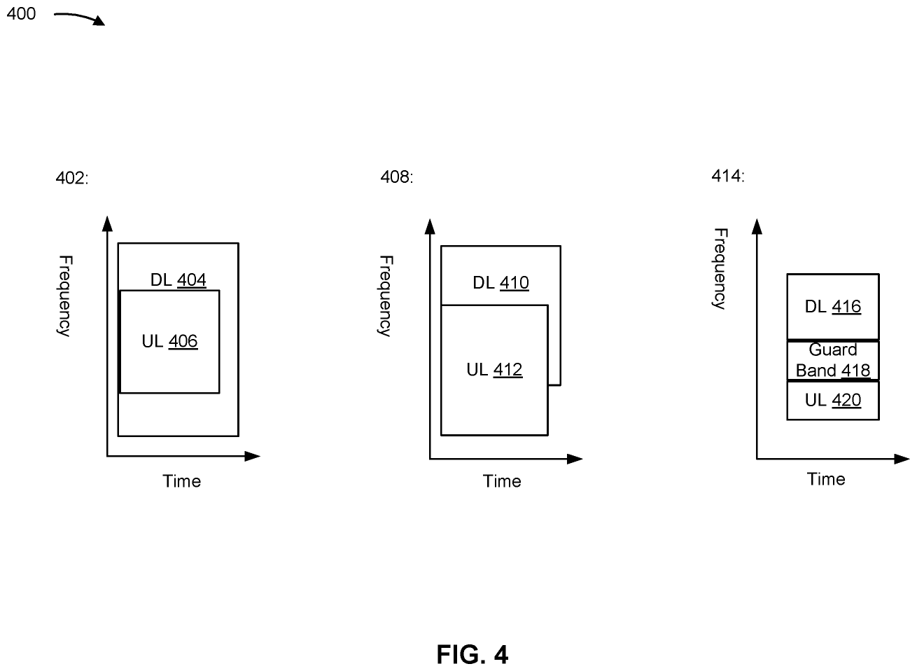

FIG. 4 is a diagram illustrating examples 400 of FD communications, in accordance with the present disclosure.

As shown by reference number 402, a downlink resource 404 and an uplink resource 406 may share the same IBFD time/frequency resource based at least in part on a full overlap. As shown by reference number 408, a downlink resource 410 and an uplink resource 412 may share the same IBFD time/frequency resource based at least in part on a partial overlap. As shown by reference number 414, a downlink resource 416 and an uplink resource 420 may be associated with a same time but different frequencies. The downlink resource 416 and the uplink resource 420 may be separated by a guard band 418.

As indicated above, FIG. 4 is provided as an example. Other examples may differ from what is described with regard to FIG. 4.

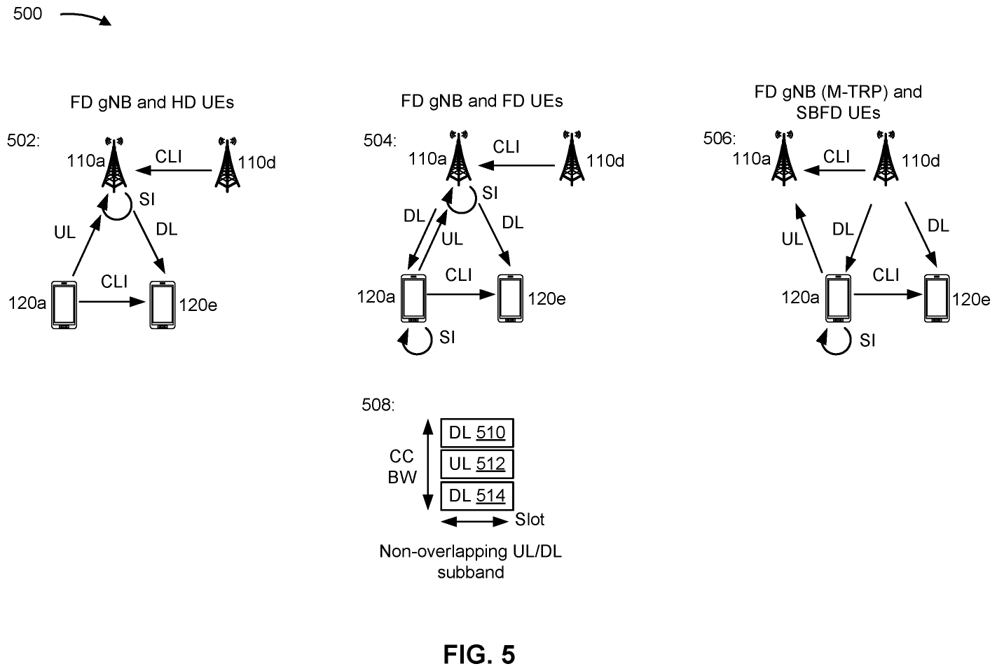

FIG. 5 is a diagram illustrating examples 500 of FD communications, in accordance with the present disclosure.

As shown by reference number 502, an FD network node (e.g., network node 110a) may communicate with HD UEs. The FD network node may be subjected to cross-link interference (CLI) from another FD network node (e.g., network node 110d). The CLI from the other FD network node may be inter-network-node CLI. The FD network node may experience self-interference (SI). The FD network node may receive an uplink transmission from a first HD UE (e.g., UE 120a), and the FD network node may transmit a downlink transmission to a second HD UE (e.g., UE 120c). The FD network node may receive the uplink transmission and transmit the downlink transmission on the same slot (e.g., a simultaneous reception/transmission). The second HD UE may be subjected to CLI from the first HD UE (e.g., inter-UE CLI).

As shown by reference number 504, an FD network node (e.g., network node 110a) may communicate with FD UEs. The FD network node may be subjected to CLI from another FD network node (e.g., network node 110d). The FD network node may experience SI. The FD network node may transmit a downlink transmission to a first FD UE (e.g., UE 120a), and the FD network node may receive an uplink transmission from the first FD UE at the same time as the downlink transmission. The FD network node may transmit a downlink transmission to a second FD UE (e.g., UE 120c). The second HD UE may be subjected to CLI from the first HD UE. The first UE may experience SI.

As shown by reference number 506, a first FD network node (e.g., network node 110a), which may be associated with multiple transmission reception points (TRPs), may communicate with SBFD UEs. The first FD network node may be subjected to CLI from a second FD network node (e.g., network node 110d). The first FD network node may receive an uplink transmission from a first SBFD UE (e.g., UE 120a). The second FD network node may transmit downlink transmissions to both the first SBFD UE and a second SBFD UE (e.g., UE 120c). The second SBFD UE may be subjected to CLI from the first SBFD UE. The first SBFD UE may experience SI.

As shown by reference number 508, an SBFD slot may be associated with a non-overlapping uplink/downlink sub-band. The SBFD slot may be associated with a simultaneous transmission/reception of a downlink/uplink on a sub-band basis. Within a component carrier bandwidth, an uplink resource 512 may be in between, in a frequency domain, a first downlink resource 510 and a second downlink resource 514. The first downlink resource 510, the second downlink resource 514, and the uplink resource 512 may all be associated with the same time.

An SBFD operation may increase an uplink duty cycle, which may result in a latency reduction (e.g., a downlink signal may be received in uplink-only slots, which may enable latency savings) and uplink coverage improvement. The SBFD operation may improve a system capacity, resource utilization, and/or spectrum efficiency. The SBFD operation may enable a flexible and dynamic uplink/downlink resource adaptation according to uplink/downlink traffic in a robust manner.

As indicated above, FIG. 5 is provided as an example. Other examples may differ from what is described with regard to FIG. 5.

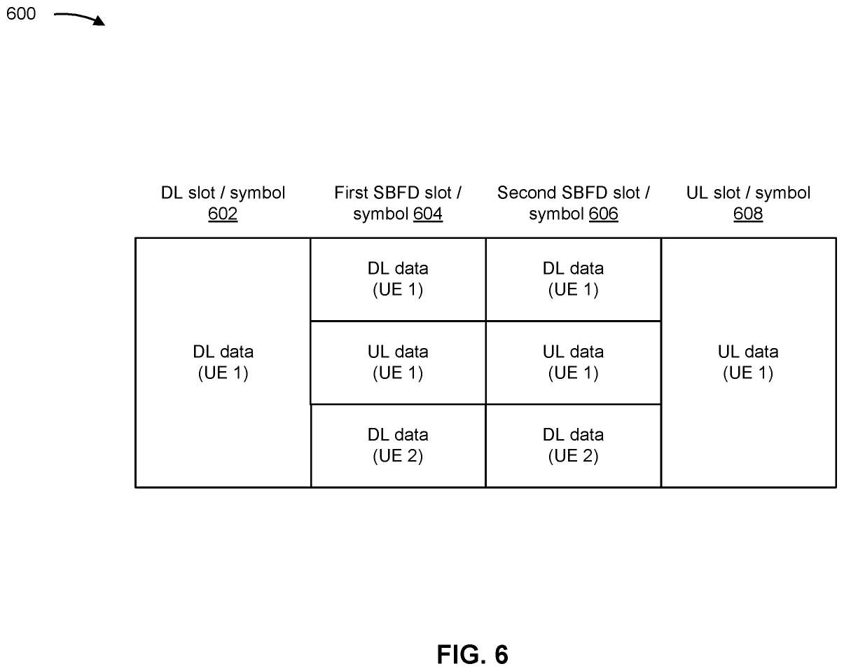

FIG. 6 is a diagram illustrating an example 600 of an SBFD slot format, in accordance with the present disclosure.

A slot format may be defined as an SBFD slot. The SBFD slot may be a slot in which a band is used for both uplink and downlink transmissions. The uplink and downlink transmissions may occur in overlapping bands (e.g., IBFD) or in adjacent bands (e.g., SBFD). In a given SBFD symbol, an HD UE may either transmit in an uplink band or receive in a downlink band. In the given SBFD symbol, an FD UE may transmit in the uplink band and/or receive in the downlink band in the same slot. The SBFD slot may include downlink-only symbols, uplink-only symbols, or FD symbols.

As shown in FIG. 6, a downlink slot/symbol may be used to convey downlink data for a first UE. A first SBFD symbol/slot may be used to convey downlink data for the first UE, uplink data for the first UE, and downlink data for a second UE. The first UE may be an FD UE. The second UE may be an HD UE. A second SBFD symbol/slot may be used to convey downlink data for the first UE, uplink data for the first UE, and downlink data for the second UE. An uplink slot/symbol may be used to convey uplink data for the first UE.

As indicated above, FIG. 6 is provided as an example. Other examples may differ from what is described with regard to FIG. 6.

A CSI-RS resource configuration may be defined for SBFD. A frequency resource allocation for CSI-RS may be defined across downlink subbands for SBFD-aware UEs. In a first option, a frequency resource allocation may be associated with two contiguous CSI-RS resources that are linked to each other. Additional signaling may be needed to link the two CSI-RS resources in two downlink subbands. In a second option, the frequency resource allocation may be associated with one CSI-RS resource. The one CSI-RS resource may be associated with a non-contiguous CSI-RS resource allocation. A new RRC structure may be needed to configure non-contiguous resource blocks (RBs) for one CSI-RS resource, which may involve additional signalling overhead. Alternatively, the one CSI-RS resource may be associated with one contiguous CSI-RS resource allocation with non-contiguous CSI-RS resources derived by excluding frequency resources outside downlink subband(s). An existing signaling design for a CSI-RS resource configuration may be reused, and potential unaligned boundaries between the CSI-RS resource configuration and SBFD subbands may be resolved. Regardless of whether the frequency resource allocation is based at least in part on the two contiguous CSI-RS resources or the one CSI-RS resource, a CSI-RS sequence generation may not be impacted. A UE complexity may be based at least in part on a UE capability of a maximum number of configured CSI-RS resources and a processing of non-contiguous CSI-RS resources.

For SBFD-aware UEs, a CSI report may be associated with a periodic/semi-persistent CSI-RS, at least, across SBFD symbols and non-SBFD symbols in different slots (e.g., each CSI-RS resource within a slot may have either all SBFD symbols or all non-SBFD symbols). In a first option, the CSI report may involve separate CSI reporting for SBFD symbols and non-SBFD symbols. In a second option, the CSI report may involve the same CSI reporting for SBFD symbols and non-SBFD symbols.

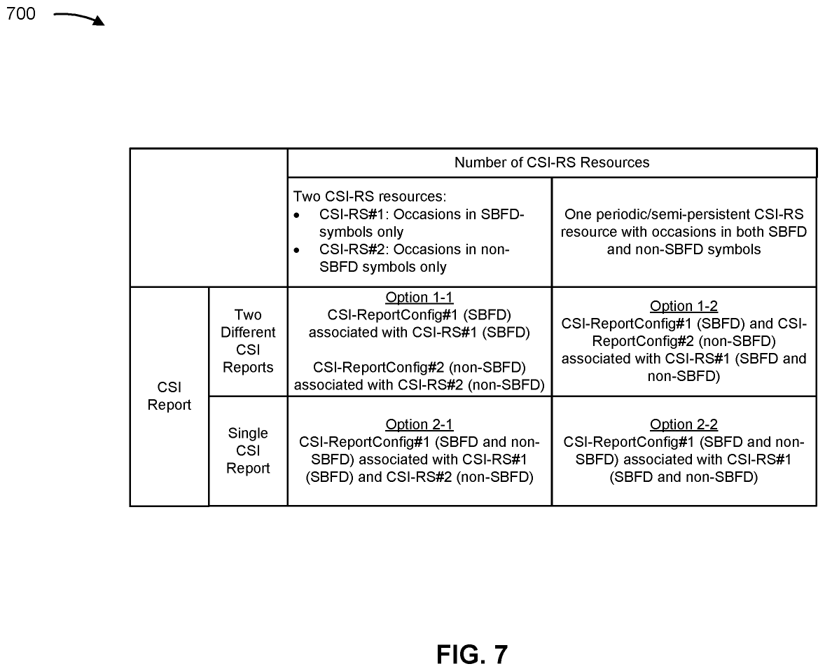

FIG. 7 is a diagram illustrating an example 700 of a CSI reporting for SBFD symbols and non-SBFD symbols, in accordance with the present disclosure.

As shown in FIG. 7, in Option 1-1, CSI report configuration #1 (SBFD) may be associated with CSI-RS #1 (SBFD) and CSI report configuration #2 (non-SBFD) may be associated with CSI-RS #2 (non-SBFD). Two CSI-RS resources (e.g., CSI-RS #1 and CSI-RS #2) may be used, where CSI-RS #1 may be associated with occasions in SBFD symbols only and CSI-RS #2 may be associated with occasions in non-SBFD symbols only. In Option 1-2, CSI report configuration #1 (SBFD) and CSI report configuration #2 (non-SBFD) may be associated with CSI-RS #1 (SBFD and non-SBFD). The CSI report configuration #1 (SBFD) and the CSI report configuration #2 (non-SBFD) may be associated with the same CSI-RS resource. One periodic or semi-persistent CSI-RS resource with occasions in both SBFD and non-SBFD symbols may be used. Option 1-1 and Option 1-2 may be associated with two different CSI reports. In Option 2-1, CSI report configuration #1 (SBFD and non-SBFD) may be associated with CSI-RS #1 (SBFD) and CSI-RS #2 (non-SBFD). The same CSI report configuration may be associated with two CSI-RS resources, where CSI-RS #1 may be associated with occasions in SBFD symbols only and CSI-RS #2 may be associated with occasions in non-SBFD symbols only. In Option 2-2. CSI report configuration #1 (SBFD and non-SBFD) may be associated with CSI-RS #1 (SBFD and non-SBFD). The same CSI report configuration may be associated with the same CSI-RS resource. The same CSI-RS resource may be one periodic or semi-persistent CSI-RS resource with occasions in both SBFD and non-SBFD symbols.

As indicated above, FIG. 7 is provided as an example. Other examples may differ from what is described with regard to FIG. 7.

As part of UE supported features, a UE may support a CSI report framework (csi-ReportFramework). The CSI report framework may be associated with a CSI reporting capability. The CSI report framework may be associated with a plurality of components, which may indicate features supported by the UE when reporting CSI to a network node. A first component may be associated with a maximum number of periodic CSI report setting per bandwidth part (BWP) for CSI report (maxNumberPeriodicCSI-PerBWP-ForCSI-Report). A second component may be associated with a maximum number of aperiodic CSI report setting per BWP for beam report (maxNumberAperiodicCSI-PerBWP-ForCSI-Report). A third component may be associated with a maximum number of semi-persistent CSI report setting per BWP for CSI report (maxNumberSemiPersistentCSI-PerBWP-ForCSI-Report). A fourth component may be associated with a maximum number of periodic CSI report setting per BWP for beam report (maxNumberPeriodicCSI-PerBWP-ForBeamReport). A fifth component may be associated with a maximum number of configured aperiodic CSI triggering states in a CSI aperiodic trigger state list (CSI-AperiodicTriggerStateList) per component carrier (CC) (maxNumberAperiodicCSI-PerBWP-ForBeamReport). A sixth component may be associated with a maximum number of aperiodic CSI report setting per BWP for CSI report (maxNumberAperiodicCSI-triggeringStatePerCC). A seventh component may be associated with a maximum number of semi-persistent CSI report setting per BWP for beam report (maxNumberSemiPersistentCSI-PerBWP-ForBeamReport). An eighth component may be associated with the UE processing Y CSI report(s) simultaneously in a CC (simultaneousCSI-ReportsPerCC). The CSI reports may be periodic, semi-persistent, or aperiodic CSI, and the CSI reports may be associated with any latency class and/or codebook type. A ninth component may be associated with the UE processing X CSI report(s) simultaneously across all CCs (simultaneousCSI-ReportsAllCC). The CSI reports may be periodic, semi-persistent, or aperiodic CSI, and the CSI reports may be associated with any latency class and/or codebook type.

Other MIMO capabilities than the fifth component may further restrict (or reduce) the number of simultaneous CSI reports that the UE is required to update. The CSI report framework, for the fourth component and the fifth component, may include a beam report and a CSI report. Each component may be independent from each other. A CSI report setting may be counted in a CC indicated by a parameter carrier in a CSI resource configuration (CSI-ResourceConfig).

As part of the UE supported features, the UE may support a Type I single panel codebook. The Type I single panel codebook may be associated with a plurality of components, which may indicate features supported by the UE when reporting the Type I single panel codebook to the network node. A first component may be associated with a list of supported combinations (supportedCSI-RS-ResourceList), where each combination may be based at least in part on a maximum number of transmit ports in one resource (maxNumberTxPortsPerResource), a maximum number of resources (maxNumberResourcesPerBand), and a total number of transmit ports across all CCs (totalNumberTxPortsPerBand) simultaneously (e.g., not necessarily in the same slot). A second component may be associated with supported codebook mode(s). A third component may be associated with a maximum number of CSI-RS resources in a resource set.

When calculating the list of supported combinations (e.g., a first component calculation), CSI-RS resources and CSI-RS ports associated with one CSI-RS resource may be counted N times when the CSI-RS resource is referred to by N CSI-RS report settings. A maximum size of the list of supported combinations may be 16. A candidate value set for the maximum number of transmit ports in one resource may be {2, 4, 8, 12, 16, 24, 32}. A candidate value set of the max number of resources may be from {1 to 64}. A candidate value set of the total number of ports, including both channel and non-zero-power (NZP)-CSI-RS based interference measurements, may be from {2 to 256}.

As part of the UE supported features, the UE may support a Type I multi-panel codebook. The Type I multi-panel codebook may be associated with a plurality of components, which may indicate features supported by the UE when reporting the Type I multi-panel codebook to the network node. A first component may be associated with a list of supported combinations (supportedCSI-RS-ResourceList). A second component may be associated with supported codebook mode(s) (modes). A third component may be associated with a supported number of panels (nrofPanels). A fourth component may be associated with a maximum number of CSI-RS resources in a resource set (maxNumberCSI-RS-PerResourceSet).

As part of the UE supported features, the UE may support a Type II codebook. The Type II codebook may be associated with a plurality of components, which may indicate features supported by the UE when reporting the Type II codebook to the network node. A first component may be associated with a list of supported combinations (supportedCSI-RS-ResourceList). A second component may be associated with a parameter (parameterLx). The parameter (e.g., parameter “Lx”) may be associated with a number of beams in a codebook generation, where x is an index of transmit ports, corresponding to 4, 8, 12, 16, 24 and 32 ports. A third component may be associated with an amplitude scaling type (amplitudeScalingType). A fourth component may be associated with an amplitude subset restriction level (amplitude SubsetRestriction).

As part of the UE supported features, the UE may support a Type II codebook with port selection. The Type II codebook with port selection may be associated with a plurality of components, which may indicate features supported by the UE when reporting the Type II codebook with port selection to the network node. A first component may be associated with a list of supported combinations (supportedCSI-RS-ResourceList). A second component may be associated with a parameter (parameterLx). The parameter (e.g., parameter “Lx”) may be associated with a number of selected ports in a codebook generation, where x is an index of transmit ports, corresponding to 4, 8, 12, 16, 24 and 32 ports. A third component may be associated with an amplitude scaling type (amplitudeScalingType).

For the Type I multi-panel codebook, the Type II codebook, and/or the Type II codebook with port selection, for the purpose of calculating the list of supported combinations, CSI-RS resources and CSI-RS ports associated with one CSI-RS resource may be counted N times when the CSI-RS resource is referred to by N CSI-RS report settings.

A UE may perform CSI reporting in an SBFD network. For a CSI report in SBFD, a first CSI report configuration (SBFD) and a second CSI report configuration (non-SBFD) may be associated with a CSI-RS resource (SBFD and non-SBFD) (e.g., Option 1-2). The CSI report may be associated with a single CSI-RS resource with occasions in SBFD/HD slots. The CSI report may be associated with two CSI report configurations corresponding to SBFD/HD. The single CSI-RS resource may be in two occasions of SBFD and HD, and two CSI report configurations may correspond to the single CSI-RS resource.

In this example, a CSI-RS resource may be counted twice in terms of a UE capability for a CSI report framework, a Type I single panel codebook, a Type I multi-panel codebook, a Type II codebook, a Type II codebook with port selection, and/or an e-Type-II codebook. The CSI-RS resource may be counted twice in terms of the UE capability based at least in part on the CSI-RS resource being associated with two CSI report configurations corresponding to SBFD/HD. In some examples, the CSI-RS resource may be counted two or more times in terms of the UE capability, depending on a number of CSI report configurations. When the CSI-RS resource is counted twice in terms of the UE capability, a limitation on a number of CSI-RS resources to be configured may be imposed on the UE. For example, when a network node needs to configure X CSI-RS resources in HD, the UE may need to support (2×X) CSI-RS resources (e.g., two times X CSI-RS resources) for SBFD. The UE may count the number of CSI-RS resources as two, even though only the single CSI-RS resource is used, which may cause the UE to reach a maximum count more quickly, as compared to when the single CSI-RS resource is not counted two times. As a result, in SBFD, the UE would need to be able to support a larger number of CSI-RS resources, which may create an undue capability burden on the UE, and may thereby degrade a performance of the UE.

In various aspects of techniques and apparatuses described herein, a UE may transmit, to a network node, capability signaling associated with a codebook for a CSI report. The capability signaling may indicate a maximum number of supported CSI-RS resources for an SBFD operation. In some aspects, the capability signaling may be based at least in part on changed counting criteria for the SBFD operation. For a calculation of the maximum number of supported CSI-RS resources, a number of CSI-RS resources and a number of CSI-RS ports associated with one CSI-RS resource may be counted N times based at least in part on the one CSI-RS resource being referred to by N CSI-RS report settings and the N CSI-RS report settings having a same duplexing type, and N is an integer value. The same duplexing type may be an SBFD type or an HD type. Alternatively, for the calculation of the maximum number of supported CSI-RS resources, a number of CSI-RS resources and a number of CSI-RS ports associated with one CSI-RS resource may be counted a maximum of Nl or N2 times (e.g., max (N1, N2) may be used for counting) based at least in part on the one CSI-RS resource being referred to by N1 CSI-RS report settings for HD and N2 CSI-RS report settings for SBFD, and N1 and N2 are integer values.

In some aspects, the capability signaling may be based at least in part on codebook UE features for the SBFD operation. The capability signaling may indicate first codebook UE features associated with an HD operation and second codebook UE features associated with the SBFD operation. The first codebook UE features may be used for counting the maximum number of supported resources for the HD operation. The second codebook UE features may be used for counting the maximum number of supported resources for the SBFD operation. Alternatively, the capability signaling may indicate codebook UE features associated with the HD operation, codebook UE features associated with the SBFD operation, and/or codebook UE features associated with both the HD operation and the SBFD operation. The codebook UE features associated with the HD operation may be used for counting the maximum number of supported resources for the HD operation. The codebook UE features associated with the SBFD operation may be used for counting the maximum number of supported resources for the SBFD operation.

In some aspects, depending on the changed counting criteria for the SBFD operation or the codebook UE features for the SBFD operation, the maximum number of supported CSI-RS resources may be appropriately counted for the HD operation or the SBFD operation. The UE may not necessarily count the one CSI-RS resource twice in terms of a UE capability based at least in part on the CSI-RS resource being associated with two CSI report configurations corresponding to SBFD/HD. The UE may not reach a maximum count more quickly, as compared to when the one CSI-RS resource is counted two times. As a result, in SBFD, the UE may not be required to support a larger number of CSI-RS resources, which may prevent an undue capability burden on the UE, thereby improving a performance of the UE.

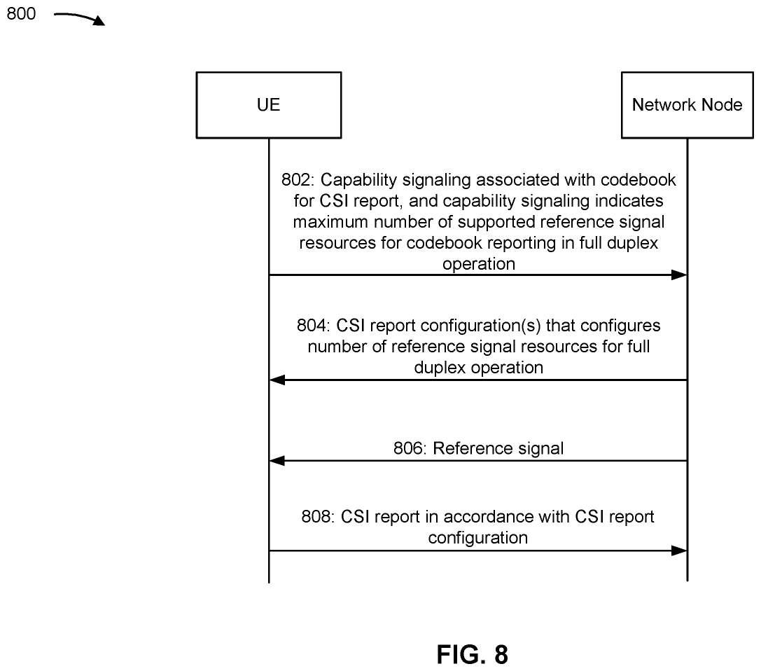

FIG. 8 is a diagram illustrating an example 800 associated with capability signaling for codebook reporting in an FD operation, in accordance with the present disclosure. As shown in FIG. 8, example 800 includes communication between a UE (e.g., UE 120) and a network node (e.g., network node 110). In some aspects, the UE and the network node may be included in a wireless network, such as wireless network 100.

As shown by reference number 802, the UE may transmit, to the network node, capability signaling associated with a codebook for a CSI report. The capability signaling may indicate a maximum number of supported reference signal resources for codebook reporting in an FD operation. The FD operation may be an SBFD operation, where the SBFD operation may be associated with SBFD slot(s). The UE may appropriately count the maximum number of supported reference signal resources based at least in part on changed counting criteria for the FD operation or codebook UE features for the FD operation. The maximum number of supported reference signal resources for codebook reporting may be a maximum number of supported CSI-RS resources.

In some aspects, with respect to the changed counting criteria, for a calculation of the maximum number of supported reference signal resources, a number of reference signal resources and a number of reference signal ports associated with one reference signal resource may be counted N times based at least in part on the one reference signal resource being referred to by N reference signal report settings and the N reference signal report settings having a same duplexing type, and N is an integer value. The number of reference signal resources may be a number of CSI-RS resources. The number of reference signal ports may be a number of CSI-RS reports. The same duplexing type may be an FD type or an HD type. In some aspects, for a calculation of the maximum number of supported reference signal resources, a number of reference signal resources and a number of reference signal ports associated with one reference signal resource may be counted a maximum of N1 or N2 times based at least in part on the one reference signal resource being referred to by N1 reference signal report settings for a half-duplex operation and N2 reference signal report settings for the full duplex operation, and N1 and N2 are integer values.

In some aspects, with respect to the changed counting criteria, for a calculation of the maximum number of supported CSI-RS resources, a number of CSI-RS resources and a number of CSI-RS ports associated with one CSI-RS resource may be counted N times based at least in part on the one CSI-RS resource being referred to by N CSI-RS report settings and the N CSI-RS report settings having a same duplexing type, and N is an integer value. The same duplexing type may be an SBFD type or an HD type.

Alternatively, for the calculation of the maximum number of supported resources, a number of CSI-RS resources and a number of CSI-RS ports associated with one CSI-RS resource may be counted a maximum of N1 or N2 times based at least in part on the one CSI-RS resource being referred to by N1 CSI-RS report settings for HD and N2 CSI-RS report settings for SBFD, and N1 and N2 are integer values. In some aspects, the codebook may be a Type I single panel codebook, a Type I multi-panel codebook, a Type II codebook, a Type 2 codebook with port selection, or an e-Type-II codebook.

In some aspects, a condition for counting may be revised, such that CSI-RS resources and CSI-RS ports associated with one CSI-RS resource may be counted N times when the CSI-RS resource is referred to by N CSI-RS report settings and the N CSI-RS report settings have the same duplexing type (e.g., SBFD or HD). The UE may count the CSI-RS resources and the CSI-RS ports within the one CSI-RS resources N times when the CSI-RS resource is referred to by N CSI-RS report settings and the N CSI-RS report settings have the same duplexing type (e.g., SBFD or HD). When the CSI-RS resource is referred to by N/HD reports and N2 SBFD reports, the UE may use a maximum of (N1, N2) for counting the CSI-RS resources and the CSI-RS ports within the one CSI-RS resources. When the N CSI-RS report settings are all HD or all SBFD, the UE may follow a legacy behavior (e.g., count CSI-RS resources and CSI-RS ports associated with one CSI-RS resource N times when the one CSI-RS resource is referred to by N CSI-RS report settings). When the N CSI-RS report settings are not all HD or not all SBFD, the UE may follow the revised condition for counting. Further, at least a subset of the N reports may have a common configuration and be intended for reporting HD/SBFD CSI based at least in part on different occasions of the one CSI-RS resource.

In some aspects, with respect to the codebook UE features, the capability signaling may indicate first codebook UE features associated with an HD operation and second codebook UE features associated with the SBFD operation. The HD operation may be associated with HD slot(s). The second codebook UE features may be independent of the first codebook UE features. In some aspects, existing codebook UE features (e.g., codebook UE features associated with a Type I single panel codebook, a Type I multi-panel codebook, a Type II codebook, and a Type 2 codebook with port selection, as defined in Sections 2-36, 2-40, 2-41, 2-43, respectively, in 3GPP TS 38.822) may be only used for indicating a UE capability for the HD operation. New codebook UE features may be defined for the SBFD operation. The existing codebook UE features for the HD operation may not be dependent on the new codebook UE features for the SBFD operation. The existing codebook UE features and the new codebook UE features may both be dependent on a general CSI report framework (e.g., as defined in Section 2-35 in 3GPP TS 38.822).

In some aspects, the capability signaling may indicate a first component that is specific to the HD operation and a first component that is specific to the FD operation (or SBFD operation). The first component that is specific to the FD operation may be dependent on the first component that is specific to the HD operation. The first component that is specific to the HD operation may be associated with a maximum number of supported transmit ports in one resource, a maximum number of supported reference signal resources for the HD operation, and a total number of supported transmit ports across a plurality of component carriers. The first component that is specific to the FD operation may be associated with a maximum number of supported transmit ports in one reference signal resource, the maximum number of supported reference signal resources for the FD operation, and a total number of supported transmit ports across a plurality of component carriers. The capability signaling may indicate a second component that is common to the HD operation and the FD operation, and the second component may be associated with supported codebook modes. The capability signaling may indicate a third component that is common to the HD operation and the FD operation, and the third component may be associated with a maximum number of reference signal resources in a resource set.

In some aspects, additional codebook UE features may be defined. The second component and the third component may be common for HD/SBFD operations. An additional first component (e.g., the first component that is specific to the SBFD operation) may be defined for the SBFD operation. SBFD codebook UE features may be dependent on HD codebook UE features. In other words, the HD codebook UE features may include prerequisite UE features for the SBFD codebook UE features.

As shown by reference number 804, the UE may receive, from the network node and based at least in part on the capability signaling, one or more CSI report configurations. The one or more CSI report configurations may configure a number of reference signal resources (e.g., CSI-RS resources) for the FD operation based at least in part on the capability signaling. The CSI report may indicate the number of reference signal resources for the FD operation, which may be based at least in part on the maximum number of supported reference signal resources for the FD operation, as indicated by the UE.

As shown by reference number 806, the UE may receive, from the network node, a reference signal (e.g., a CSI-RS). The UE may receive the reference signal based at least in part on the number of reference signal resources configured for the FD operation. A reference signal resource, of the number of reference signal resources, may be associated with both the FD operation (or SBFD operation) and the HD operation. For example, the reference signal resource may be a single reference signal resource with occasions in FD/HD slots.

As shown by reference number 808, the UE may transmit, to the network node and based at least in part on the CSI report configuration, the CSI report. The CSI report may indicate a measurement associated with the reference signal. The network node may perform a mitigation action based at least in part on the measurement associated with the CSI-RS (e.g., when the measurement satisfies a threshold).

As indicated above, FIG. 8 is provided as an example. Other examples may differ from what is described with regard to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with capability signaling for codebook reporting in an FD operation.

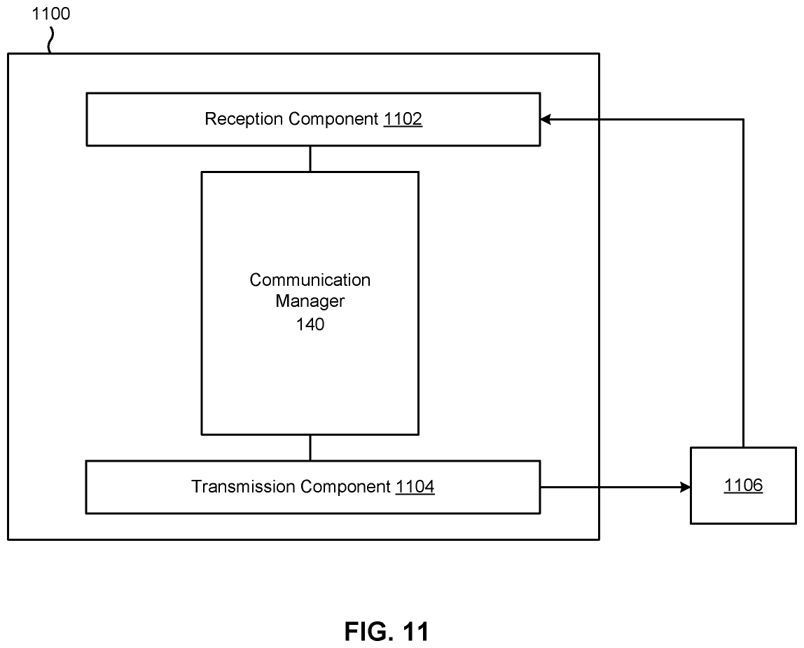

As shown in FIG. 9, in some aspects, process 900 may include transmitting capability signaling associated with a codebook for a CSI report, the capability signaling indicating a maximum number of supported reference signal resources for codebook reporting in a full duplex operation (block 910). For example, the UE (e.g., using communication manager 140 and/or transmission component 1104, depicted in FIG. 11) may transmit capability signaling associated with a codebook for a CSI report, the capability signaling indicating a maximum number of supported reference signal resources for codebook reporting in a full duplex operation, as described above.

As further shown in FIG. 9, in some aspects, process 900 may include receiving, based at least in part on the capability signaling, one or more CSI report configurations indicating a number of reference signal resources for the full duplex operation (block 920). For example, the UE (e.g., using communication manager 140 and/or reception component 1102, depicted in FIG. 11) may receive, based at least in part on the capability signaling, one or more CSI report configurations indicating a number of reference signal resources for the full duplex operation, as described above.

Process 900 may include additional aspects, such as any single aspect or any combination of aspects described below and/or in connection with one or more other processes described elsewhere herein.

In a first aspect, process 900 includes receiving a reference signal, and transmitting, based at least in part on the one or more CSI report configurations, the CSI report, wherein the CSI report indicates a measurement associated with the reference signal.

In a second aspect, alone or in combination with the first aspect, the reference signal is a CSI-RS, the maximum number of supported reference signal resources for codebook reporting is a maximum number of supported CSI-RS resources for codebook reporting, and the number of reference signal resources is a number of CSI-RS resources.

In a third aspect, alone or in combination with one or more of the first and second aspects, the full duplex operation is an SBFD operation.

In a fourth aspect, alone or in combination with one or more of the first through third aspects, for a calculation of the maximum number of supported reference signal resources, a number of reference signal resources and a number of reference signal ports associated with one reference signal resource are counted N times based at least in part on the one reference signal resource being referred to by N reference signal report settings and the N reference signal report settings having a same duplexing type, and N is an integer value.

In a fifth aspect, alone or in combination with one or more of the first through fourth aspects, the same duplexing type is a full duplex type.

In a sixth aspect, alone or in combination with one or more of the first through fifth aspects, the same duplexing type is a half-duplex type.

In a seventh aspect, alone or in combination with one or more of the first through sixth aspects, for a calculation of the maximum number of supported reference signal resources, a number of reference signal resources and a number of reference signal ports associated with one reference signal resource are counted a maximum of N1 or N2 times based at least in part on the one reference signal resource being referred to by N1 reference signal report settings for a half-duplex operation and N2 reference signal report settings for the full duplex operation, and N1 and N2 are integer values.

In an eighth aspect, alone or in combination with one or more of the first through seventh aspects, the capability signaling indicates first codebook UE features associated with a half-duplex operation and second codebook UE features associated with the full duplex operation.

In a ninth aspect, alone or in combination with one or more of the first through eighth aspects, the second codebook UE features are independent of the first codebook UE features.

In a tenth aspect, alone or in combination with one or more of the first through ninth aspects, the capability signaling indicates a first component that is specific to a half-duplex operation and a first component that is specific to the full duplex operation.

In an eleventh aspect, alone or in combination with one or more of the first through tenth aspects, the first component that is specific to the full duplex operation is dependent on the first component that is specific to the half-duplex operation.

In a twelfth aspect, alone or in combination with one or more of the first through eleventh aspects, the first component that is specific to the half-duplex operation is associated with a maximum number of supported transmit ports in one reference signal resource, a maximum number of supported reference signal resources, and a total number of supported transmit ports across a plurality of component carriers, and the first component that is specific to the full duplex operation is associated with a maximum number of supported transmit ports in one reference signal resource, the maximum number of supported reference signal resources for the full duplex operation, and a total number of supported transmit ports across a plurality of component carriers.

In a thirteenth aspect, alone or in combination with one or more of the first through twelfth aspects, the capability signaling indicates a second component that is common to a half-duplex operation and the full duplex operation, and the second component is associated with supported codebook modes.

In a fourteenth aspect, alone or in combination with one or more of the first through thirteenth aspects, the capability signaling indicates a third component that is common to a half-duplex operation and the full duplex operation, and the third component is associated with a maximum number of reference signal resources in a resource set.

In a fifteenth aspect, alone or in combination with one or more of the first through fourteenth aspects, the codebook is a Type I single panel codebook, a Type I multi-panel codebook, a Type II codebook, a Type 2 codebook with port selection, or an enhanced Type II (e-Type-II) codebook.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with capability signaling for codebook reporting in an FD operation.

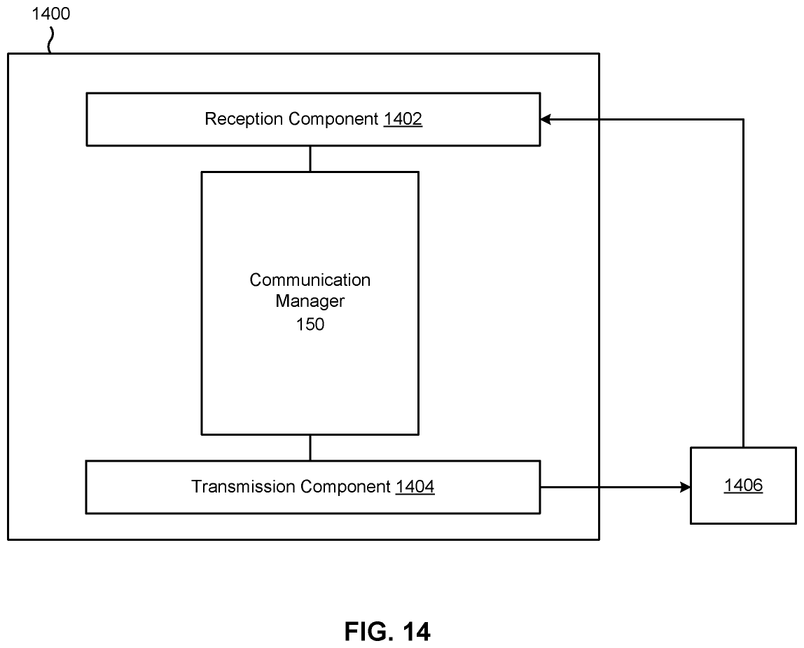

As shown in FIG. 10, in some aspects, process 1000 may include receiving capability signaling associated with a codebook for a CSI report, the capability signaling indicating a maximum number of supported reference signal resources for codebook reporting in a full duplex operation (block 1010). For example, the network node (e.g., using communication manager 150 and/or reception component 1402, depicted in FIG. 14) may receive capability signaling associated with a codebook for a CSI report, the capability signaling indicating a maximum number of supported reference signal resources for codebook reporting in a full duplex operation, as described above.

As further shown in FIG. 10, in some aspects, process 1000 may include transmitting, based at least in part on the capability signaling, one or more CSI report configurations indicating a number of reference signal resources for the full duplex operation (block 1020). For example, the network node (e.g., using communication manager 150 and/or transmission component 1404, depicted in FIG. 14) may transmit, based at least in part on the capability signaling, one or more CSI report configurations indicating a number of reference signal resources for the full duplex operation, as described above.

Process 1000 may include additional aspects, such as any single aspect or any combination of aspects described below and/or in connection with one or more other processes described elsewhere herein.

In a first aspect, process 1000 includes transmitting a reference signal, and receiving, based at least in part on the one or more CSI report configurations, the CSI report, wherein the CSI report indicates a measurement associated with the reference signal.

In a second aspect, alone or in combination with the first aspect, the reference signal is a CSI-RS, the maximum number of supported reference signal resources for codebook reporting is a maximum number of supported CSI-RS resources for codebook reporting, and the number of reference signal resources is a number of CSI-RS resources.

In a third aspect, alone or in combination with one or more of the first and second aspects, the full duplex operation is an SBFD operation.

In a fourth aspect, alone or in combination with one or more of the first through third aspects, for a calculation of the maximum number of supported reference signal resources, a number of reference signal resources and a number of reference signal ports associated with one reference signal resource are counted N times based at least in part on the one reference signal resource being referred to by N reference signal report settings and the N reference signal report settings having a same duplexing type, and N is an integer value.

In a fifth aspect, alone or in combination with one or more of the first through fourth aspects, the same duplexing type is a full duplex type.

In a sixth aspect, alone or in combination with one or more of the first through fifth aspects, the same duplexing type is a half-duplex type.

In a seventh aspect, alone or in combination with one or more of the first through sixth aspects, for a calculation of the maximum number of supported reference signal resources, a number of reference signal resources and a number of reference signal ports associated with one reference signal resource are counted a maximum of N1 or N2 times based at least in part on the one reference signal resource being referred to by N1 reference signal report settings for a half-duplex operation and N2 reference signal report settings for the full duplex operation, and N1 and N2 are integer values.

In an eighth aspect, alone or in combination with one or more of the first through seventh aspects, the capability signaling indicates first codebook UE features associated with a half-duplex operation and second codebook UE features associated with the full duplex operation.

In a ninth aspect, alone or in combination with one or more of the first through eighth aspects, the second codebook UE features are independent of the first codebook UE features.

In a tenth aspect, alone or in combination with one or more of the first through ninth aspects, the capability signaling indicates a first component that is specific to a half-duplex operation and a first component that is specific to the full duplex operation.

In an eleventh aspect, alone or in combination with one or more of the first through tenth aspects, the first component that is specific to the full duplex operation is dependent on the first component that is specific to the half-duplex operation.

In a twelfth aspect, alone or in combination with one or more of the first through eleventh aspects, the first component that is specific to the half-duplex operation is associated with a maximum number of supported transmit ports in one reference signal resource, a maximum number of supported reference signal resources, and a total number of supported transmit ports across a plurality of component carriers, and the first component that is specific to the full duplex operation is associated with a maximum number of supported transmit ports in one reference signal resource, the maximum number of supported reference signal resources for the full duplex operation, and a total number of supported transmit ports across a plurality of component carriers.

In a thirteenth aspect, alone or in combination with one or more of the first through twelfth aspects, the capability signaling indicates a second component that is common to a half-duplex operation and the full duplex operation, and the second component is associated with supported codebook modes.

In a fourteenth aspect, alone or in combination with one or more of the first through thirteenth aspects, the capability signaling indicates a third component that is common to a half-duplex operation and the full duplex operation, and the third component is associated with a maximum number of reference signal resources in a resource set.

In a fifteenth aspect, alone or in combination with one or more of the first through fourteenth aspects, the codebook is a Type I single panel codebook, a Type I multi-panel codebook, a Type II codebook, a Type 2 codebook with port selection, or e-Type-II codebook.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140.

In some aspects, the apparatus 1100 may be configured to perform one or more operations described herein in connection with FIG. 8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

The transmission component 1104 may transmit capability signaling associated with a codebook for a CSI report, the capability signaling indicating a maximum number of supported reference signal resources for codebook reporting in a full duplex operation. The reception component 1102 may receive, based at least in part on the capability signaling, one or more CSI report configurations indicating a number of reference signal resources for the full duplex operation. The reception component 1102 may receive a reference signal. The transmission component 1104 may transmit, based at least in part on the one or more CSI report configurations, the CSI report, wherein the CSI report indicates a measurement associated with the reference signal.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

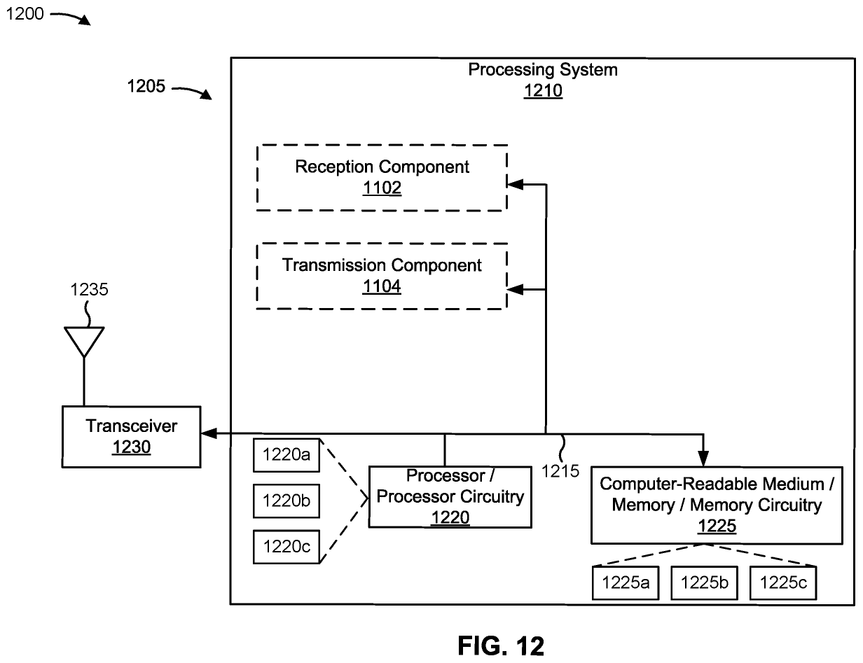

FIG. 12 is a diagram illustrating an example 1200 of a hardware implementation for an apparatus 1205 employing a processing system 1210, in accordance with the present disclosure. The apparatus 1205 may be a UE.

The processing system 1210 may be implemented with a bus architecture, represented generally by the bus 1215. The bus 1215 may include any number of interconnecting buses and bridges depending on the specific application of the processing system 1210 and the overall design constraints. The bus 1215 links together various circuits including one or more processors and/or hardware components, represented by the processor (or processing circuitry) 1220, the illustrated components, and the computer-readable medium/memory (or memory circuitry) 1225. The processor 1220 may include multiple processors, such as processor 1220a, memory 1220b, and memory 1220c. The memory 1225 may include multiple memories, such as memory 1225a, memory 1225b, and memory 1225c. The bus 1215 may also link various other circuits, such as timing sources, peripherals, voltage regulators, and/or power management circuits.

The processing system 1210 may be coupled to a transceiver 1230. The transceiver 1230 is coupled to one or more antennas 1235. The transceiver 1230 provides a means for communicating with various other apparatuses over a transmission medium. The transceiver 1230 receives a signal from the one or more antennas 1235, extracts information from the received signal, and provides the extracted information to the processing system 1210, specifically the reception component 1102. In addition, the transceiver 1230 receives information from the processing system 1210, specifically the transmission component 1104, and generates a signal to be applied to the one or more antennas 1235 based at least in part on the received information.

The processing system 1210 includes a processor 1220 coupled to a computer-readable medium/memory 1225. The processor 1220 is responsible for general processing, including the execution of software stored on the computer-readable medium/memory 1225. The software, when executed by the processor 1220, causes the processing system 1210 to perform the various functions described herein for any particular apparatus. The computer-readable medium/memory 1225 may also be used for storing data that is manipulated by the processor 1220 when executing software. The processing system further includes at least one of the illustrated components. The components may be software modules running in the processor 1220, resident/stored in the computer readable medium/memory 1225, one or more hardware modules coupled to the processor 1220, or some combination thereof.

In some aspects, the processing system 1210 may be a component of the UE 120 and may include the memory 282 and/or at least one of the transmit MIMO processor 266, the receive processor 258, and/or the controller/processor 280. In some aspects, the apparatus 1205 for wireless communication includes means for transmitting capability signaling associated with a codebook for a CSI report, the capability signaling indicating a maximum number of supported reference signal resources for codebook reporting in a full duplex operation; and means for receiving, based at least in part on the capability signaling, one or more CSI report configurations indicating a number of reference signal resources for the full duplex operation. The aforementioned means may be one or more of the aforementioned components of the apparatus 1100 and/or the processing system 1210 of the apparatus 1205 configured to perform the functions recited by the aforementioned means. As described elsewhere herein, the processing system 1210 may include the transmit MIMO processor 266, the receive processor 258, and/or the controller/processor 280. In one configuration, the aforementioned means may be the transmit MIMO processor 266, the receive processor 258, and/or the controller/processor 280 configured to perform the functions and/or operations recited herein.

FIG. 12 is provided as an example. Other examples may differ from what is described in connection with FIG. 12.

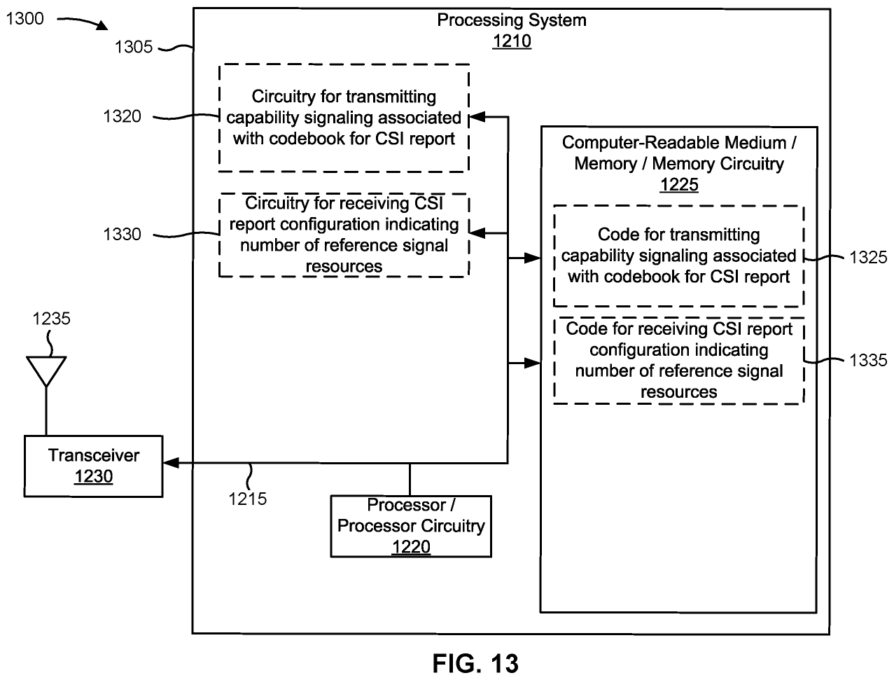

FIG. 13 is a diagram illustrating an example 1300 of an implementation of code and circuitry for an apparatus 1305, in accordance with the present disclosure. The circuitry may include processing circuitry and memory circuitry. The apparatus 1305 may be a UE, or a UE may include the apparatus 1305.

As shown in FIG. 13, the apparatus 1305 may include circuitry for transmitting capability signaling associated with a codebook for a CSI report, the capability signaling indicating a maximum number of supported reference signal resources for codebook reporting in a full duplex operation (circuitry 1320). For example, the circuitry 1320 may enable the apparatus 1305 to transmit capability signaling associated with a codebook for a CSI report, the capability signaling indicating a maximum number of supported reference signal resources for codebook reporting in a full duplex operation.

As shown in FIG. 13, the apparatus 1305 may include, stored in computer-readable medium 1225, code for transmitting capability signaling associated with a codebook for a CSI report, the capability signaling indicating a maximum number of supported reference signal resources for codebook reporting in a full duplex operation (code 1325). For example, the code 1325, when executed by processor 1220, may cause processor 1220 to cause transceiver 1230 to transmit capability signaling associated with a codebook for a CSI report, the capability signaling indicating a maximum number of supported reference signal resources for codebook reporting in a full duplex operation.

As shown in FIG. 13, the apparatus 1305 may include circuitry for receiving, based at least in part on the capability signaling, one or more CSI report configurations indicating a number of reference signal resources for the full duplex operation (circuitry 1330). For example, the circuitry 1330 may enable the apparatus 1305 to receive, based at least in part on the capability signaling, one or more CSI report configurations indicating a number of reference signal resources for the full duplex operation.

As shown in FIG. 13, the apparatus 1305 may include, stored in computer-readable medium 1225, code for receiving, based at least in part on the capability signaling, one or more CSI report configurations indicating a number of reference signal resources for the full duplex operation (code 1335). For example, the code 1335, when executed by processor 1220, may cause processor 1220 to cause transceiver 1230 to receive, based at least in part on the capability signaling, one or more CSI report configurations indicating a number of reference signal resources for the full duplex operation.

FIG. 13 is provided as an example. Other examples may differ from what is described in connection with FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150.

In some aspects, the apparatus 1400 may be configured to perform one or more operations described herein in connection with FIG. 8. Additionally, or alternatively, the apparatus 1400 may be configured to perform one or more processes described herein, such as process 1000 of FIG. 10. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the network node described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1404 may be co-located with the reception component 1402 in one or more transceivers.

The reception component 1402 may receive capability signaling associated with a codebook for a CSI report, the capability signaling indicating a maximum number of supported reference signal resources for codebook reporting in a full duplex operation. The transmission component 1404 may transmit, based at least in part on the capability signaling, one or more CSI report configurations indicating a number of reference signal resources for the full duplex operation. The transmission component 1404 may transmit a reference signal. The reception component 1402 may receive, based at least in part on the one or more CSI report configurations, the CSI report, wherein the CSI report indicates a measurement associated with the reference signal.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

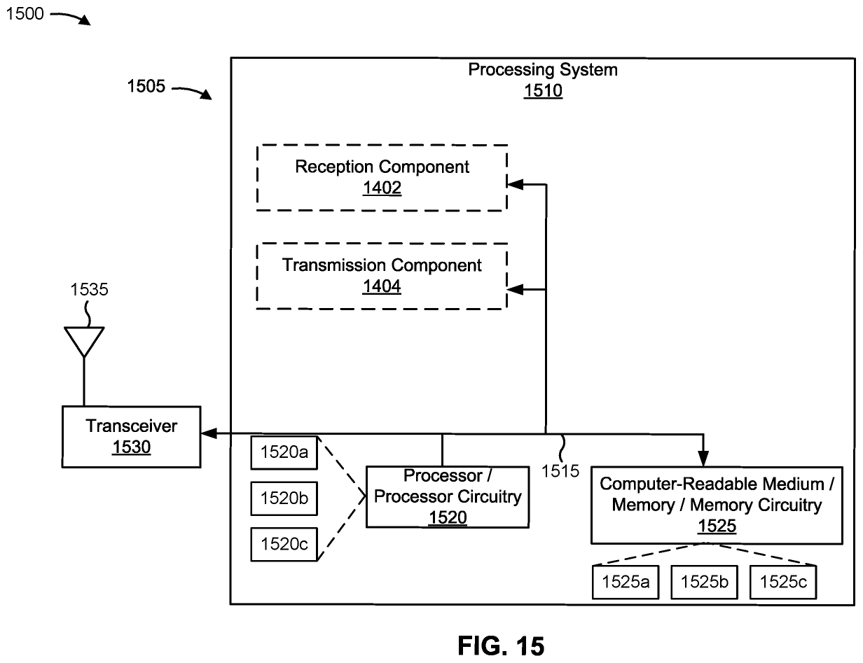

FIG. 15 is a diagram illustrating an example 1500 of a hardware implementation for an apparatus 1505 employing a processing system 1510, in accordance with the present disclosure. The apparatus 1505 may be a network node.

The processing system 1510 may be implemented with a bus architecture, represented generally by the bus 1515. The bus 1515 may include any number of interconnecting buses and bridges depending on the specific application of the processing system 1510 and the overall design constraints. The bus 1515 links together various circuits including one or more processors and/or hardware components, represented by the processor (or processing circuitry) 1520, the illustrated components, and the computer-readable medium/memory (or memory circuitry) 1525. The processor 1520 may include multiple processors, such as processor 1520a, memory 1520b, and memory 1520c. The memory 1525 may include multiple memories, such as memory 1525a, memory 1525b, and memory 1525c. The bus 1515 may also link various other circuits, such as timing sources, peripherals, voltage regulators, and/or power management circuits.

The processing system 1510 may be coupled to a transceiver 1530. The transceiver 1530 is coupled to one or more antennas 1535. The transceiver 1530 provides a means for communicating with various other apparatuses over a transmission medium. The transceiver 1530 receives a signal from the one or more antennas 1535, extracts information from the received signal, and provides the extracted information to the processing system 1510, specifically the reception component 1402. In addition, the transceiver 1530 receives information from the processing system 1510, specifically the transmission component 1404, and generates a signal to be applied to the one or more antennas 1535 based at least in part on the received information.

The processing system 1510 includes a processor 1520 coupled to a computer-readable medium/memory 1525. The processor 1520 is responsible for general processing, including the execution of software stored on the computer-readable medium/memory 1525. The software, when executed by the processor 1520, causes the processing system 1510 to perform the various functions described herein for any particular apparatus. The computer-readable medium/memory 1525 may also be used for storing data that is manipulated by the processor 1520 when executing software. The processing system further includes at least one of the illustrated components. The components may be software modules running in the processor 1520, resident/stored in the computer readable medium/memory 1525, one or more hardware modules coupled to the processor 1520, or some combination thereof.

In some aspects, the processing system 1510 may be a component of the base station 110 and may include the memory 242 and/or at least one of the transmit MIMO processor 230, the RX processor 238, and/or the controller/processor 240. In some aspects, the apparatus 1505 for wireless communication includes means for receiving capability signaling associated with a codebook for a CSI report, the capability signaling indicating a maximum number of supported reference signal resources for codebook reporting in a full duplex operation; and/or means for transmitting, based at least in part on the capability signaling, one or more CSI report configurations indicating a number of reference signal resources for the full duplex operation. The aforementioned means may be one or more of the aforementioned components of the apparatus 1400 and/or the processing system 1510 of the apparatus 1505 configured to perform the functions recited by the aforementioned means. As described elsewhere herein, the processing system 1510 may include the transmit MIMO processor 230, the receive processor 238, and/or the controller/processor 240. In one configuration, the aforementioned means may be the transmit MIMO processor 230, the receive processor 238, and/or the controller/processor 240 configured to perform the functions and/or operations recited herein.

FIG. 15 is provided as an example. Other examples may differ from what is described in connection with FIG. 15.

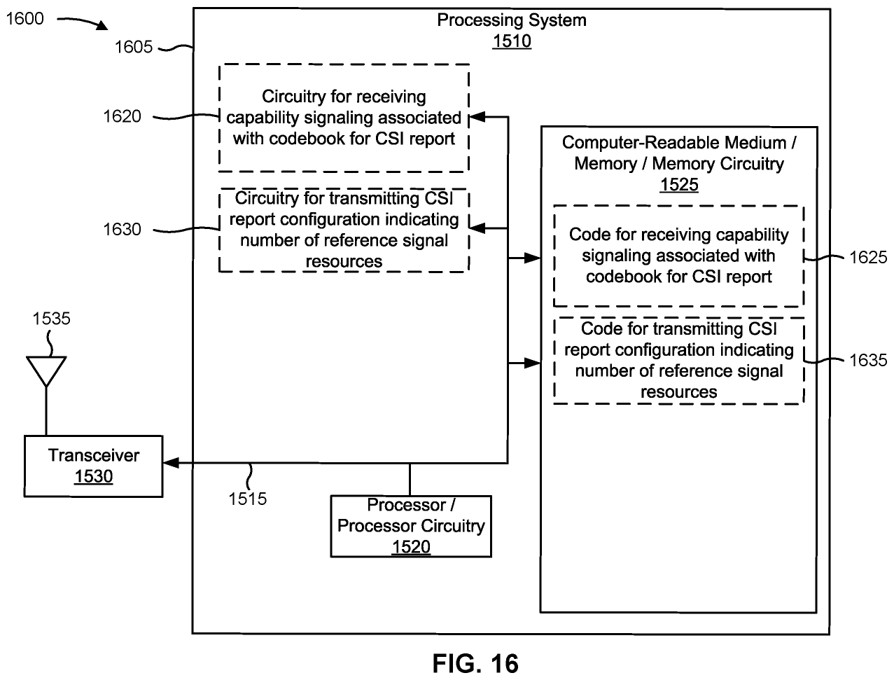

FIG. 16 is a diagram illustrating an example 1600 of an implementation of code and circuitry for an apparatus 1605, in accordance with the present disclosure. The circuitry may include processing circuitry and memory circuitry. The apparatus 1605 may be a network node, or a network node may include the apparatus 1605.

As shown in FIG. 16, the apparatus 1605 may include circuitry for receiving capability signaling associated with a codebook for a CSI report, the capability signaling indicating a maximum number of supported reference signal resources for codebook reporting in a full duplex operation (circuitry 1620). For example, the circuitry 1620 may enable the apparatus 1605 to receive capability signaling associated with a codebook for a CSI report, the capability signaling indicating a maximum number of supported reference signal resources for codebook reporting in a full duplex operation.

As shown in FIG. 16, the apparatus 1605 may include, stored in computer-readable medium 1525, code for receiving capability signaling associated with a codebook for a CSI report, the capability signaling indicating a maximum number of supported reference signal resources for codebook reporting in a full duplex operation (code 1625). For example, the code 1625, when executed by processor 1520, may cause processor 1520 to cause transceiver 1530 to receive capability signaling associated with a codebook for a CSI report, the capability signaling indicating a maximum number of supported reference signal resources for codebook reporting in a full duplex operation.

As shown in FIG. 16, the apparatus 1605 may include circuitry for transmitting, based at least in part on the capability signaling, one or more CSI report configurations indicating a number of reference signal resources for the full duplex operation (circuitry 1630). For example, the circuitry 1630 may enable the apparatus 1605 to transmit, based at least in part on the capability signaling, one or more CSI report configurations indicating a number of reference signal resources for the full duplex operation.

As shown in FIG. 16, the apparatus 1605 may include, stored in computer-readable medium 1525, code for transmitting, based at least in part on the capability signaling, one or more CSI report configurations indicating a number of reference signal resources for the full duplex operation (code 1635). For example, the code 1635, when executed by processor 1520, may cause processor 1520 to cause transceiver 1530 to transmit, based at least in part on the capability signaling, one or more CSI report configurations indicating a number of reference signal resources for the full duplex operation.

FIG. 16 is provided as an example. Other examples may differ from what is described in connection with FIG. 16.

The following provides an overview of some Aspects of the present disclosure:

Aspect 1: A method of wireless communication performed at a user equipment (UE), comprising: transmitting capability signaling associated with a codebook for a channel state information (CSI) report, the capability signaling indicating a maximum number of supported reference signal resources for codebook reporting in a full duplex operation; and receiving, based at least in part on the capability signaling, one or more CSI report configurations indicating a number of reference signal resources for the full duplex operation.

Aspect 2: The method of Aspect 1, further comprising: receiving a reference signal; and transmitting, based at least in part on the one or more CSI report configurations, the CSI report, wherein the CSI report indicates a measurement associated with the reference signal.

Aspect 3: The method of Aspect 2, wherein the reference signal is a channel state information reference signal (CSI-RS), the maximum number of supported reference signal resources for codebook reporting is a maximum number of supported CSI-RS resources for codebook reporting, and the number of reference signal resources is a number of CSI-RS resources.

Aspect 4: The method of any of Aspects 1-3, wherein the full duplex operation is a subband full duplex (SBFD) operation.

Aspect 5: The method of any of Aspects 1-4, wherein, for a calculation of the maximum number of supported reference signal resources, a number of reference signal resources and a number of reference signal ports associated with one reference signal resource are counted N times based at least in part on the one reference signal resource being referred to by N reference signal report settings and the N reference signal report settings having a same duplexing type, and N is an integer value.

Aspect 6: The method of Aspect 6, wherein the same duplexing type is a full duplex type.

Aspect 7: The method of Aspect 6, wherein the same duplexing type is a half-duplex type.

Aspect 8: The method of any of Aspects 1-7, wherein, for a calculation of the maximum number of supported reference signal resources, a number of reference signal resources and a number of reference signal ports associated with one reference signal resource are counted a maximum of N1 or N2 times based at least in part on the one reference signal resource being referred to by N1 reference signal report settings for a half-duplex operation and N2 reference signal report settings for the full duplex operation, and N1 and N2 are integer values.

Aspect 9: The method of any of Aspects 1-8, wherein the capability signaling indicates first codebook UE features associated with a half-duplex operation and second codebook UE features associated with the full duplex operation.

Aspect 10: The method of Aspect 9, wherein the second codebook UE features are independent of the first codebook UE features.

Aspect 11: The method of any of Aspects 1-10, wherein the capability signaling indicates a first component that is specific to a half-duplex operation and a first component that is specific to the full duplex operation.

Aspect 12: The method of Aspect 11, wherein the first component that is specific to the full duplex operation is dependent on the first component that is specific to the half-duplex operation.

Aspect 13: The method of Aspect 11, wherein: the first component that is specific to the half-duplex operation is associated with a maximum number of supported transmit ports in one reference signal resource, a maximum number of supported reference signal resources, and a total number of supported transmit ports across a plurality of component carriers; and the first component that is specific to the full duplex operation is associated with a maximum number of supported transmit ports in one reference signal resource, the maximum number of supported reference signal resources for the full duplex operation, and a total number of supported transmit ports across a plurality of component carriers.

Aspect 14: The method of any of Aspects 1-13, wherein the capability signaling indicates a second component that is common to a half-duplex operation and the full duplex operation, and the second component is associated with supported codebook modes.

Aspect 15: The method of any of Aspects 1-14, wherein the capability signaling indicates a third component that is common to a half-duplex operation and the full duplex operation, and the third component is associated with a maximum number of reference signal resources in a resource set.

Aspect 16: The method of any of Aspects 1-15, wherein the codebook is a Type I single panel codebook, a Type I multi-panel codebook, a Type II codebook, a Type 2 codebook with port selection, or an enhanced Type II (e-Type-II) codebook.

Aspect 17: A method of wireless communication performed at a network node, comprising: receiving capability signaling associated with a codebook for a channel state information (CSI) report, the capability signaling indicating a maximum number of supported reference signal resources for codebook reporting in a full duplex operation; and transmitting, based at least in part on the capability signaling, one or more CSI report configurations indicating a number of reference signal resources for the full duplex operation.

Aspect 18: The method of Aspect 17, further comprising: transmitting a reference signal; and receiving, based at least in part on the one or more CSI report configurations, the CSI report, wherein the CSI report indicates a measurement associated with the reference signal.

Aspect 19: The method of Aspect 18, wherein the reference signal is a channel state information reference signal (CSI-RS), the maximum number of supported reference signal resources for codebook reporting is a maximum number of supported CSI-RS resources for codebook reporting, and the number of reference signal resources is a number of CSI-RS resources.

Aspect 20: The method of any of Aspects 17-19, wherein the full duplex operation is a subband full duplex (SBFD) operation.

Aspect 21: The method of any of Aspects 17-20, wherein, for a calculation of the maximum number of supported reference signal resources, a number of reference signal resources and a number of reference signal ports associated with one reference signal resource are counted N times based at least in part on the one reference signal resource being referred to by N reference signal report settings and the N reference signal report settings having a same duplexing type, and N is an integer value.

Aspect 22: The method of Aspect 21, wherein the same duplexing type is a full duplex type.

Aspect 23: The method of Aspect 21, wherein the same duplexing type is a half-duplex type.

Aspect 24: The method of any of Aspects 17-23, wherein, for a calculation of the maximum number of supported reference signal resources, a number of reference signal resources and a number of reference signal ports associated with one reference signal resource are counted a maximum of N1 or N2 times based at least in part on the one reference signal resource being referred to by N1 reference signal report settings for a half-duplex operation and N2 reference signal report settings for the full duplex operation, and N1 and N2 are integer values.

Aspect 25: The method of any of Aspects 17-24, wherein the capability signaling indicates first codebook user equipment (UE) features associated with a half-duplex operation and second codebook UE features associated with the full duplex operation.

Aspect 26: The method of Aspect 25, wherein the second codebook UE features are independent of the first codebook UE features.

Aspect 27: The method of any of Aspects 17-26, wherein the capability signaling indicates a first component that is specific to a half-duplex operation and a first component that is specific to the full duplex operation.

Aspect 28: The method of Aspect 27, wherein the first component that is specific to the full duplex operation is dependent on the first component that is specific to the half-duplex operation.

Aspect 29: The method of Aspect 27, wherein: the first component that is specific to the half-duplex operation is associated with a maximum number of supported transmit ports in one reference signal resource, a maximum number of supported reference signal resources, and a total number of supported transmit ports across a plurality of component carriers; and the first component that is specific to the full duplex operation is associated with a maximum number of supported transmit ports in one reference signal resource, the maximum number of supported reference signal resources for the full duplex operation, and a total number of supported transmit ports across a plurality of component carriers.

Aspect 30: The method of any of Aspects 17-29, wherein the capability signaling indicates a second component that is common to a half-duplex operation and the full duplex operation, and the second component is associated with supported codebook modes.

Aspect 31: The method of any of Aspects 17-30, wherein the capability signaling indicates a third component that is common to a half-duplex operation and the full duplex operation, and the third component is associated with a maximum number of reference signal resources in a resource set.

Aspect 32: The method of any of Aspects 17-31, wherein the codebook is a Type I single panel codebook, a Type I multi-panel codebook, a Type II codebook, a Type 2 codebook with port selection, or an enhanced Type II (e-Type-II) codebook.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-16.

Aspect 34: An apparatus for wireless communication at a device, the apparatus comprising one or more memories and one or more processors coupled to the one or more memories, the one or more processors configured to cause the device to perform the method of one or more of Aspects 1-16.

Aspect 35: An apparatus for wireless communication, the apparatus comprising at least one means for performing the method of one or more of Aspects 1-16.

Aspect 36: A non-transitory computer-readable medium storing code for wireless communication, the code comprising instructions executable by one or more processors to perform the method of one or more of Aspects 1-16.

Aspect 37: A non-transitory computer-readable medium storing a set of instructions for wireless communication, the set of instructions comprising one or more instructions that, when executed by one or more processors of a device, cause the device to perform the method of one or more of Aspects 1-16.

Aspect 38: A device for wireless communication, the device comprising a processing system that includes one or more processors and one or more memories coupled with the one or more processors, the processing system configured to cause the device to perform the method of one or more of Aspects 1-16.

Aspect 39: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 1-16.

Aspect 40: An apparatus for wireless communication at a user equipment (UE), the apparatus comprising one or more memories and one or more processors coupled to the one or more memories, the one or more processors configured to individually or collectively cause the UE to perform the method of one or more of Aspects 1-16.

Aspect 41: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 1-16.

Aspect 42: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 17-32.

Aspect 43: An apparatus for wireless communication at a device, the apparatus comprising one or more memories and one or more processors coupled to the one or more memories, the one or more processors configured to cause the device to perform the method of one or more of Aspects 17-32.

Aspect 44: An apparatus for wireless communication, the apparatus comprising at least one means for performing the method of one or more of Aspects 17-32.

Aspect 45: A non-transitory computer-readable medium storing code for wireless communication, the code comprising instructions executable by one or more processors to perform the method of one or more of Aspects 17-32.

Aspect 46: A non-transitory computer-readable medium storing a set of instructions for wireless communication, the set of instructions comprising one or more instructions that, when executed by one or more processors of a device, cause the device to perform the method of one or more of Aspects 17-32.

Aspect 47: A device for wireless communication, the device comprising a processing system that includes one or more processors and one or more memories coupled with the one or more processors, the processing system configured to cause the device to perform the method of one or more of Aspects 17-32.

Aspect 48: An apparatus for wireless communication at a network node, comprising: a processing system that includes processor circuitry and memory circuitry that stores code and is coupled with the processor circuitry, the processing system configured to cause the UE to perform the method of one or more of Aspects 17-32.

Aspect 49: An apparatus for wireless communication at a network node, the apparatus comprising one or more memories and one or more processors coupled to the one or more memories, the one or more processors configured to individually or collectively cause the network node to perform the method of one or more of Aspects 17-32.

Aspect 50: An apparatus for wireless communication at a network node, comprising: a processing system that includes processor circuitry and memory circuitry that stores code and is coupled with the processor circuitry, the processing system configured to cause the network node to perform the method of one or more of Aspects 17-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, and configured to cause the UE to:
transmit capability signaling associated with a codebook for a channel state information (CSI) report, the capability signaling indicating a maximum number of supported reference signal resources for codebook reporting in a full duplex operation; and
receive, based at least in part on the capability signaling, one or more CSI report configurations indicating a number of reference signal resources for the full duplex operation.

2. The apparatus of claim 1, wherein the one or more processors are further configured to cause the UE to:
receive a reference signal; and
transmit, based at least in part on the one or more CSI report configurations, the CSI report, wherein the CSI report indicates a measurement associated with the reference signal.

3. The apparatus of claim 2, wherein the reference signal is a channel state information reference signal (CSI-RS), the maximum number of supported reference signal resources for codebook reporting is a maximum number of supported CSI-RS resources for codebook reporting, and the number of reference signal resources is a number of CSI-RS resources.

4. The apparatus of claim 1, wherein the full duplex operation is a subband full duplex (SBFD) operation.

5. The apparatus of claim 1, wherein, for a calculation of the maximum number of supported reference signal resources, a number of reference signal resources and a number of reference signal ports associated with one reference signal resource are counted N times based at least in part on the one reference signal resource being referred to by N reference signal report settings and the N reference signal report settings having a same duplexing type, and N is an integer value.

6. The apparatus of claim 5, wherein the same duplexing type is a full duplex type.

7. The apparatus of claim 5, wherein the same duplexing type is a half-duplex type.

8. The apparatus of claim 1, wherein, for a calculation of the maximum number of supported reference signal resources, a number of reference signal resources and a number of reference signal ports associated with one reference signal resource are counted a maximum of N1 or N2 times based at least in part on the one reference signal resource being referred to by N1 reference signal report settings for a half-duplex operation and N2 reference signal report settings for the full duplex operation, and N1 and N2 are integer values.

9. The apparatus of claim 1, wherein the capability signaling indicates first codebook UE features associated with a half-duplex operation and second codebook UE features associated with the full duplex operation.

10. The apparatus of claim 9, wherein the second codebook UE features are independent of the first codebook UE features.

11. The apparatus of claim 1, wherein the capability signaling indicates a first component that is specific to a half-duplex operation and a first component that is specific to the full duplex operation.

12. The apparatus of claim 11, wherein the first component that is specific to the full duplex operation is dependent on the first component that is specific to the half-duplex operation.

13. The apparatus of claim 11, wherein:
the first component that is specific to the half-duplex operation is associated with a maximum number of supported transmit ports in one reference signal resource, a maximum number of supported reference signal resources, and a total number of supported transmit ports across a plurality of component carriers; and
the first component that is specific to the full duplex operation is associated with a maximum number of supported transmit ports in one reference signal resource, the maximum number of supported reference signal resources for the full duplex operation, and a total number of supported transmit ports across a plurality of component carriers.

14. The apparatus of claim 1, wherein the capability signaling indicates a second component that is common to a half-duplex operation and the full duplex operation, and the second component is associated with supported codebook modes.

15. The apparatus of claim 1, wherein the capability signaling indicates a third component that is common to a half-duplex operation and the full duplex operation, and the third component is associated with a maximum number of reference signal resources in a resource set.

16. The apparatus of claim 1, wherein the codebook is a Type I single panel codebook, a Type I multi-panel codebook, a Type II codebook, a Type 2 codebook with port selection, or an enhanced Type II (e-Type-II) codebook.

17. An apparatus for wireless communication at a network node, comprising:
one or more memories; and
one or more processors, coupled to the one or more memories, and configured to cause the network node to:
receive capability signaling associated with a codebook for a channel state information (CSI) report, the capability signaling indicating a maximum number of supported reference signal resources for codebook reporting in a full duplex operation; and
transmit, based at least in part on the capability signaling, one or more CSI report configurations indicating a number of reference signal resources for the full duplex operation.

18. The apparatus of claim 17, wherein the one or more processors are further configured to cause the network node to:
transmit a reference signal; and
receive, based at least in part on the one or more CSI report configurations, the CSI report, wherein the CSI report indicates a measurement associated with the reference signal.

19. The apparatus of claim 18, wherein the reference signal is a channel state information reference signal (CSI-RS), the maximum number of supported reference signal resources for codebook reporting is a maximum number of supported CSI-RS resources for codebook reporting, and the number of reference signal resources is a number of CSI-RS resources.

20. The apparatus of claim 17, wherein the full duplex operation is a subband full duplex (SBFD) operation.

21. The apparatus of claim 17, wherein, for a calculation of the maximum number of supported reference signal resources, a number of reference signal resources and a number of reference signal ports associated with one reference signal resource are counted N times based at least in part on the one reference signal resource being referred to by N reference signal report settings and the N reference signal report settings having a same duplexing type, and N is an integer value.

22. The apparatus of claim 21, wherein the same duplexing type is a full duplex type or a half-duplex type.

23. The apparatus of claim 17, wherein, for a calculation of the maximum number of supported reference signal resources, a number of reference signal resources and a number of reference signal ports associated with one reference signal resource are counted a maximum of N1 or N2 times based at least in part on the one reference signal resource being referred to by N1 reference signal report settings for a half-duplex operation and N2 reference signal report settings for the full duplex operation, and N1 and N2 are integer values.

24. The apparatus of claim 17, wherein the capability signaling indicates first codebook user equipment (UE) features associated with a half-duplex operation and second codebook UE features associated with the full duplex operation, and the second codebook UE features are independent of the first codebook UE features.

25. The apparatus of claim 17, wherein the capability signaling indicates a first component that is specific to a half-duplex operation and a first component that is specific to the full duplex operation.

26. The apparatus of claim 25, wherein the first component that is specific to the full duplex operation is dependent on the first component that is specific to the half-duplex operation.

27. The apparatus of claim 25, wherein:
the first component that is specific to the half-duplex operation is associated with a maximum number of supported transmit ports in one reference signal resource, a maximum number of supported reference signal resources, and a total number of supported transmit ports across a plurality of component carriers; and
the first component that is specific to the full duplex operation is associated with a maximum number of supported transmit ports in one reference signal resource, the maximum number of supported reference signal resources for the full duplex operation, and a total number of supported transmit ports across a plurality of component carriers.

28. The apparatus of claim 17, wherein:
the capability signaling indicates a second component that is common to a half-duplex operation and the full duplex operation, and the second component is associated with supported codebook modes; and
the capability signaling indicates a third component that is common to the half-duplex operation and the full duplex operation, and the third component is associated with a maximum number of reference signal resources in a resource set.

29. A method of wireless communication performed at a user equipment (UE), comprising:
transmitting capability signaling associated with a codebook for a channel state information (CSI) report, the capability signaling indicating a maximum number of supported reference signal resources for codebook reporting in a full duplex operation; and
receiving, based at least in part on the capability signaling, one or more CSI report configurations indicating a number of reference signal resources for the full duplex operation.

30. A method of wireless communication performed at a network node, comprising:
receiving capability signaling associated with a codebook for a channel state information (CSI) report, the capability signaling indicating a maximum number of supported reference signal resources for codebook reporting in a full duplex operation; and
transmitting, based at least in part on the capability signaling, one or more CSI report configurations indicating a number of reference signal resources for the full duplex operation.
